(19) United States
(12) Patent Application Publication
(10) Pub. No.: US 2024/0373503 A1
(43) Pub. Date: Nov. 7, 2024

(54) EARLY CELL DISCONTINUOUS TRANSMISSION AND/OR DISCONTINUOUS RECEPTION SIGNALING

(71) Applicant: QUALCOMM Incorporated, San Diego, CA (US)

(72) Inventors: Sherif ELAZZOUNI, San Diego, CA (US); Hung Dinh LY, San Diego, CA (US); Le LIU, San Jose, CA (US)

(21) Appl. No.: 18/313,178

(22) Filed: May 5, 2023

(51) Int. Cl. H04W 76/28; H04W 74/08

(52) U.S. Cl. CPC H04W 76/28; H04W 74/0833

(57) ABSTRACT

Various aspects of the present disclosure generally relate to wireless communication. For example, some aspects relate to techniques to signal information related to a cell discontinuous transmission (DTX) or discontinuous reception (DRX) configuration prior to a user equipment (UE) commencing a random access channel (RACH) procedure or during the RACH procedure. In this way, after the RACH procedure is complete, the UE may start to monitor physical downlink control channel (PDCCH) occasions in a next active time associated with the cell DTX/DRX configuration. Additionally or alternatively, information related to a cell DTX configuration may be signaled in a system information block (SIB) or a multicast/broadcast service (MBS) configuration for UEs receiving MBS communications. Accordingly, the UE may refrain from attempting to decode a multicast traffic channel (MTCH) and/or refrain from attempting to decode the MTCH and a multicast control channel (MCCH) during the inactive time of the cell DTX configuration.

### FIELD OF THE DISCLOSURE

Aspects of the present disclosure generally relate to wireless communication and specifically relate to techniques and apparatuses associated with early cell discontinuous transmission (DTX) and/or discontinuous reception (DRX) signaling.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, system bandwidth and/or device transmit power). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies, massive multiple-input multiple-output (MIMO), disaggregated network architectures and network topology expansions, multiple-subscriber implementations, and/or high-precision positioning, among other examples. As the demand for mobile broadband access continues to increase, further improvements in NR may be implemented, and other radio access technologies such as 6G may be introduced to further advance mobile broadband evolution.

For various reasons, including climate change mitigation, environmental sustainability, and network cost reduction, network energy saving and/or network energy efficiency measures are expected to have increased importance in wireless network operations. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, which could potentially lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network. The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are important factors that may drive adoption and/or expansion of wireless networks.

For example, one potential technique to increase energy efficiency in a RAN may be to enable a cell discontinuous transmission (DTX) or discontinuous reception (DRX) configuration for a network node, which may generally have similar characteristics as a DRX configuration that may be configured for a UE. For example, a cell DTX/DRX configuration may include a DTX/DRX active time, during which a network node transmits and/or receives one or more channels or signals, and an opportunity for a network node to enter a sleep state during a time (for example, an inactive or non-active duration) when an entire cell (for example, including the network node and any connected mode UEs) is sleeping. For example, the cell DTX/DRX configuration may be achieved by aligning DRX configurations associated with connected mode UEs via network implementation (for example, aligning the DRX on duration for each connected mode UE) such that the network node can enter a sleep state when all connected mode UEs are in a sleep state and communicate with connected mode UEs when all connected mode UEs are awake during the aligned DRX on durations. However, in cases where the network node drops one or more physical downlink control channel (PDCCH) communications during a cell DTX inactive duration, a UE that is performing a random access channel (RACH) procedure in a cell provided by the network node may unnecessarily waste power listening for or monitoring during PDCCH occasions that coincide with the inactive duration of the DTX/DRX configuration of the network node. Similarly, in cases where a network node drops one or more multicast traffic channel (MTCH) communications and/or one or more multicast control channel (MCCH) communications during a cell DTX inactive duration, the UE may expect multicast/broadcast service (MBS) transmissions during the DTX inactive duration and unnecessarily consume power monitoring for MBS transmissions that will not occur.

### SUMMARY

Some aspects described herein relate to a user equipment (UE) for wireless communication. The UE may include one or more memories storing processor-readable code and one or more processors coupled with the one or more memories and operable to cause the UE to communicate with a network node to perform a random access channel (RACH) procedure. The one or more processors may be operable to cause the UE to receive, from the network node prior to commencement or completion of the RACH procedure, information related to a cell discontinuous transmission (DTX) or discontinuous reception (DRX) (DTX/DRX) configuration associated with the network node. The one or more processors may be operable to cause the UE to monitor, after completion of the RACH procedure, physical downlink control channel (PDCCH) occasions starting at or after a beginning of a subsequent cell DTX active time associated with the cell DTX/DRX configuration.

Some aspects described herein relate to a UE for wireless communication. The UE may include one or more memories storing processor-readable code and one or more processors coupled with the one or more memories and operable to cause the UE to receive, from a network node, information related to a cell DTX configuration associated with multicast/broadcast service (MBS) provided by the network node. The one or more processors may be operable to cause the UE to attempt to decode a multicast traffic channel (MTCH) starting at or after a beginning of a subsequent cell DTX inactive time associated with the cell DTX configuration.

Some aspects described herein relate to a method of wireless communication performed by a UE. The method may include communicating with a network node to perform a RACH procedure. The method may include receiving, from the network node prior to commencement or completion of the RACH procedure, information related to a cell DTX/DRX configuration associated with the network node. The method may include monitoring, after completion of the RACH procedure, PDCCH occasions starting at or after a beginning of a subsequent cell DTX active time associated with the cell DTX/DRX configuration.

Some aspects described herein relate to a method of wireless communication performed by a UE. The method may include receiving, from a network node, information related to a cell DTX configuration associated with MBS provided by the network node. The method may include attempting to decode an MTCH starting at or after a beginning of a subsequent cell DTX inactive time associated with the cell DTX configuration.

Some aspects described herein relate to a non-transitory computer-readable medium that stores a set of instructions for wireless communication by a UE. The set of instructions, when executed by one or more processors of the UE, may cause the UE to communicate with a network node to perform a RACH procedure. The set of instructions, when executed by one or more processors of the UE, may cause the UE to receive, from the network node prior to commencement or completion of the RACH procedure, information related to a cell DTX/DRX configuration associated with the network node. The set of instructions, when executed by one or more processors of the UE, may cause the UE to monitor, after completion of the RACH procedure, PDCCH occasions starting at or after a beginning of a subsequent cell DTX active time associated with the cell DTX/DRX configuration.

Some aspects described herein relate to a non-transitory computer-readable medium that stores a set of instructions for wireless communication. The set of instructions, when executed by one or more processors of a UE, may cause the UE to receive, from a network node, information related to a cell DTX configuration associated with MBS provided by the network node. The set of instructions, when executed by one or more processors of the UE, may cause the UE to attempt to decode an MTCH starting at or after a beginning of a subsequent cell DTX inactive time associated with the cell DTX configuration.

Some aspects described herein relate to an apparatus for wireless communication. The apparatus may include means for communicating with a network node to perform a RACH procedure. The apparatus may include means for receiving, from the network node prior to commencement or completion of the RACH procedure, information related to a cell DTX/DRX configuration associated with the network node. The apparatus may include means for monitoring, after completion of the RACH procedure, PDCCH occasions starting at or after a beginning of a subsequent cell DTX active time associated with the cell DTX/DRX configuration.

Some aspects described herein relate to an apparatus for wireless communication. The apparatus may include means for receiving, from a network node, information related to a cell DTX configuration associated with MBS provided by the network node. The apparatus may include means for attempting to decode an MTCH starting at or after a beginning of a subsequent cell DTX inactive time associated with the cell DTX configuration.

Aspects generally include a method, apparatus, system, computer program product, non-transitory computer-readable medium, user equipment, base station, network node, network entity, wireless communication device, and/or processing system as substantially described with reference to and as illustrated by the drawings and specification.

The foregoing has broadly summarized some aspects of the present disclosure. Additional aspects and associated advantages will be described hereinafter. The disclosed aspects may be used as a basis for modifying or designing other aspects for carrying out the same purposes of the present disclosure. Such equivalent aspects do not depart from the scope of the appended claims. Characteristics of the aspects disclosed herein, both their organization and method of operation, together with associated advantages will be better understood from the following description when considered in connection with the accompanying drawings. Each of the drawings is provided for the purposes of illustration and description, and not as a definition of the limits of the claims.

### BRIEF DESCRIPTION OF THE DRAWINGS

The appended drawings illustrate some aspects of the present disclosure, but are not limiting of the scope of the present disclosure because the description may enable other aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIGS. 3A-3B are diagrams illustrating examples of random access channel (RACH) procedures in accordance with the present disclosure.

FIG. 4 is a diagram illustrating an example of a discontinuous reception (DRX) configuration in accordance with the present disclosure.

FIG. 5 is a diagram illustrating an example of wasted power at a UE performing a RACH procedure with a network node operating according to a cell discontinuous transmission (DTX) configuration and/or a cell DRX configuration in accordance with the present disclosure.

FIGS. 6A-6B are diagrams illustrating examples of early cell DTX and/or DRX (DTX/DRX) signaling in accordance with the present disclosure.

FIG. 7 is a flowchart illustrating an example process performed, for example, by a UE in accordance with the present disclosure.

FIG. 8 is a diagram of an example apparatus for wireless communication in accordance with the present disclosure.

FIG. 9 is a diagram illustrating an example of a channel mapping for multicast/broadcast service (MBS) in accordance with the present disclosure.

FIG. 10 is a diagram illustrating an example of early cell DTX/DRX signaling in accordance with the present disclosure.

FIG. 11 is a flowchart illustrating an example process performed, for example, by a UE in accordance with the present disclosure.

FIG. 12 is a diagram of an example apparatus for wireless communication in accordance with the present disclosure.

### DETAILED DESCRIPTION

Various aspects of the disclosure are described hereinafter with reference to the accompanying drawings. However, this disclosure may be embodied in many different forms and is not to be construed as limited to any specific aspect presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using any quantity of the aspects set forth herein. In addition, the scope of the disclosure is intended to cover an apparatus or method that is practiced using another structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to early signaling of a cell discontinuous transmission (DTX) or discontinuous reception (DRX) (DTX/DRX) configuration associated with a network node. Some aspects more specifically relate to techniques to signal information related to the cell DTX/DRX configuration prior to or during a random access channel (RACH) procedure with a user equipment (UE) such that the UE may delay monitoring physical downlink control channel (PDCCH) occasions after the RACH procedure is complete until a next active time associated with the cell DTX/DRX configuration. In some examples, the network node may signal the information related to the cell DTX/DRX configuration to the UE in a system information block (SIB) or a paging message, whereby the UE may be made aware of the cell DTX/DRX configuration, and an associated activation state or activation time, prior to the UE starting the RACH procedure. Additionally or alternatively, in some examples, the network node may signal the information related to the cell DTX/DRX configuration to the UE during the RACH procedure (for example, in msg2 or msg4 of a four-step RACH procedure, or in msgB of a two-step RACH procedure), whereby the UE may be made aware, during the RACH procedure, of the cell DTX/DRX configuration and an associated time delay until an active or inactive time of the cell DTX/DRX cycle. Furthermore, some aspects more specifically relate to indicating a cell DTX configuration or information related to a cell DTX configuration, in a SIB or in a multicast/broadcast service (MBS) configuration. for UEs that are receiving MBS communications. Accordingly, in some examples, a UE may refrain from attempting to decode a multicast traffic channel (MTCH) during an inactive time of the cell DTX cycle. In some examples, the UE may additionally refrain from attempting to decode a multicast control channel (MCCH) during the inactive time of the cell DTX cycle (for example, depending on whether MCCH communications are dropped or not dropped during the inactive time of the cell DTX configuration).

Particular aspects of the subject matter described in this disclosure can be implemented to realize one or more of the following potential advantages. By signaling the cell DTX/DRX configuration and the associated activation state and/or activation time to the UE before commencement of or during the RACH procedure, the UE may become aware of the cell DTX/DRX configuration before completion of the RACH procedure and delay monitoring PDCCH occasions until a subsequent cell DTX/DRX active time. For example, the UE may start to monitor the PDCCH occasions at or after the beginning of the subsequent cell DTX/DRX active time. In this way, the early signaling of the cell DTX/DRX active time (for example, before or during the RACH procedure) may mitigate unnecessary power consumption that would otherwise occur if the UE were to monitor the PDCCH occasions during the inactive time of the cell DTX/DRX cycle (when the network node is not transmitting any PDCCH messages). Furthermore, in cases where a cell DTX configuration is signaled to an MBS UE in a SIB or an MBS configuration, an MBS UE may avoid unnecessary power consumption that would occur if the MBS UE were to monitor an MTCH during an inactive time of the cell DTX cycle. Furthermore, in cases where the network node also drops MCCH transmissions during the inactive time of the cell DTX cycle, the MBS UE may conserve power by not attempting to decode MCCH transmissions during the inactive time of the cell DTX cycle.

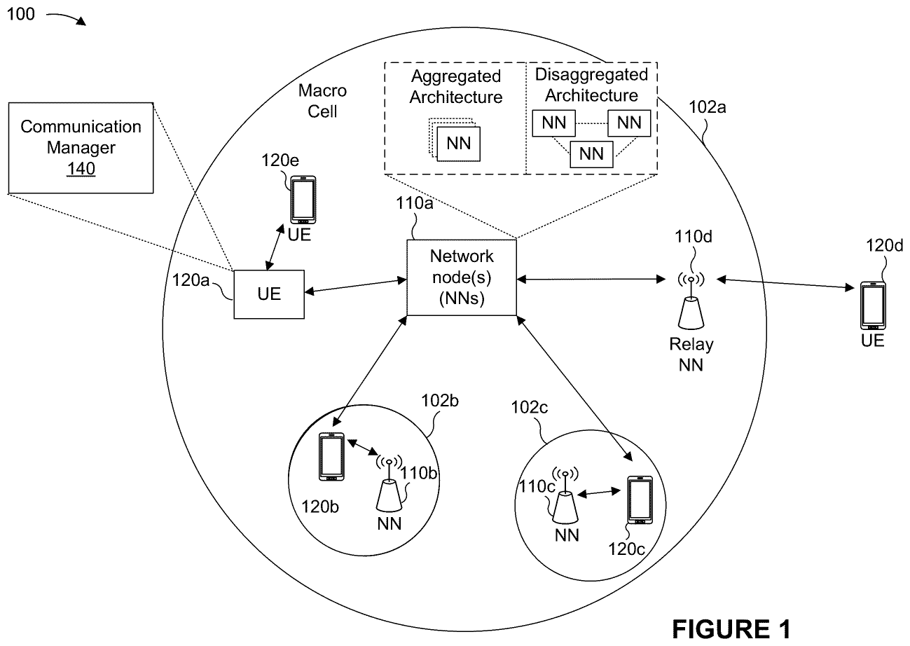

FIG. 1 is a diagram illustrating an example of a wireless network 100 in accordance with the present disclosure. The wireless network 100 may be or may include elements of a 5G (or NR) network or a 6G network, among other examples. The wireless network 100 may include multiple network nodes 110 (also referred to as network entities), shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

A network node 110 may include one or more devices that enable communication between a UE 120 and one or more components of the wireless network 100. A network node 110 may be, may include, or may be referred to as an NR network node, a 6G network node, a Node B, an eNB (for example, in 4G), a gNB (for example, in 5G), an access point (AP), a transmission reception point (TRP), a mobility element of a network, a core network node, a network element, a network equipment, and/or another type of device or devices included in a radio access network (RAN).

A network node 110 may be a single physical node or may be two or more physical nodes. For example, a network node 110 may be a device or system that implements part of a radio protocol stack, a device or system that implements a full protocol stack (such as a full gNB protocol stack), or a collection of devices or systems that collectively implement the full protocol stack. For example, and as shown, a network node 110 may be an aggregated network node, meaning that the network node 110 may use a radio protocol stack that is physically and logically integrated within a single node in the wireless network 100. For example, an aggregated network node 110 may consist of a single standalone base station or a single TRP that uses a full radio protocol stack to enable or facilitate communication between a UE 120 and a core network of the wireless network 100.

Alternatively, and as also shown, a network node 110 may be a disaggregated network node (sometimes referred to as a disaggregated base station), meaning that the network node 110 may use a protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN), such as the network configuration sponsored by the O-RAN Alliance, or in a virtualized radio access network (vRAN), also known as a cloud radio access network (C-RAN), to facilitate scaling of communication systems by separating base station functionality into multiple units that can be individually deployed.

The network nodes 110 of the wireless network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A CU may handle user plane functionality (for example, Central Unit-User Plane (CU-UP) functionality), and/or control plane functionality (for example, Central Unit-Control Plane (CU-CP) functionality). A DU may host one or more of a radio link control (RLC) layer, a medium access control (MAC) layer, and/or one or more high physical (PHY) layers depending, at least in part, on a functional split, such as a functional split defined by the Third Generation Partnership Project (3GPP). In some examples, a DU may host one or more low PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or low PHY layer functions, such as an FFT, an iFFT, beamforming, or PRACH extraction and filtering, among other examples, based on a functional split, such as a lower layer functional split. In such an architecture, each RU can be operated to handle over the air (OTA) communication with one or more UEs 120.

In some aspects, a network node 110 may include a combination of one or more CUs, one or more DUs, one or more RUs, one or more IAB nodes, one or more Near-Real Time (Near-RT) RAN Intelligent Controllers (RICs), and/or one or more Non-Real Time (Non-RT) RICs in the wireless network 100. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as within a cloud deployment.

In some examples, a network node 110 may be, may include, or may operate as an RU, a TRP, or a base station that communicates with one or more UEs 120 via a radio access link (which may be referred to as a “Uu” link or an access link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may include one or more control channels and one or more data channels. An uplink control channel may be used to transmit uplink control information (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

In some examples, the wireless network 100 may be configured for half-duplex communications and/or full-duplex communications. In half-duplex operation, a network node 110 and/or a UE 120 may only transmit or receive communications during particular time periods, such as during particular slots, symbols, or other transmission time intervals (TTIs). For example, in half-duplex operation, a wireless communication device may perform only one of transmission or reception in a particular time instance. In full-duplex operation, a wireless communication device (such as the network node 110 and/or the UE 120) may transmit and receive communications simultaneously (for example, in the same time instance). For example, a UE 120 may communicate with two network nodes 110 in a configuration that may be referred to as a multi-TRP (mTRP) configuration. In some examples, full-duplex operation may be enabled for a UE 120 but not for a network node 110. For example, a UE 120 may simultaneously transmit an UL transmission to a first network node 110 and receive a DL transmission from a second network node 110 in the same time instance. In some other examples, full-duplex operation may be enabled for a network node 110 but not for a UE 120. For example, a network node 110 may simultaneously transmit a DL transmission to a first UE 120 and receive an UL transmission from a second UE 120 in the same time instance. In some examples, full-duplex operation may be enabled for both a network node 110 and a UE 120. Full-duplex communication increases the capacity of the network and the radio access link.

The UEs 120 may be physically dispersed throughout the wireless network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 may include or may be included in a housing that houses components associated with the UE 120, such as one or more processor components and/or one or more memory components. One or more of the processor components may be coupled with one or more of the memory components and/or other components. For example, the processor components (for example, one or more processors) and the memory components (for example, a memory) may be operatively coupled, communicatively coupled, electronically coupled, or electrically coupled with one another.

Some UEs 120 may be considered machine-type communication (MTC) or evolved or enhanced machine-type communication (eMTC) UEs (or further enhanced eMTC (feMTC), or enhanced feMTC (efeMTC), or further evolutions thereof, all of which may be simply referred to as “MTC”). An MTC UE may be, may include, or may be included in or coupled with a robot, a drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless network 100).

Some UEs 120 may be classified according to different categories in association with different complexities and/or different capabilities. UEs 120 in a first category may facilitate massive IoT in the wireless network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart cities deployment, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may communicate using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless network 100. In some other deployments and configurations, a UE 120 (instead of a network node 110) may perform, or collaborate or negotiate with one or more other UEs to perform, scheduling operations, resource selection operations, and/or other operations described elsewhere herein for sidelink communications.

Downlink and uplink resources may include time domain resources (frames, subframes, slots, symbols), frequency domain resources (frequency bands, frequency carriers, subcarriers, resource blocks, resource elements), spatial domain resources (particular transmit directions or beam parameters), or a combination thereof. Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP. A BWP may be dynamically configured (for example, by a network node 110 transmitting a downlink control information (DCI) configuration to the one or more UEs 120) and/or reconfigured, which means that a BWP can be adjusted in real-time (or near-real-time) based on changing network conditions in the wireless network 100 and/or based on the specific requirements of the one or more UEs 120. This enables more efficient use of the available frequency domain resources in the wireless network 100 in that smaller amounts of frequencies may be allocated to a BWP for a UE 120 (which may reduce the amount of frequencies that a UE 120 is required to monitor), leaving a greater amount of frequencies to be spread across multiple UEs 120. Thus, BWPs may also assist in the implementation of lower-capability UEs 120 by facilitating the configuration of smaller bandwidths for communication by such UEs 120.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span over a set of consecutive CRBs. Each BWP may be associated with its own numerology (indicating a sub-carrier spacing (SCS) and cycling prefix (CP)). A UE 120 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the UE 120's operating bandwidth within the cell's operating bandwidth while all other BWPs that the UE 120 is configured with are deactivated. On deactivated BWPs, the UE 120 does not transmit or receive any data.

Some network nodes 110 (for example, a base station, an RU, or a TRP) may provide communication coverage for a particular geographic area. In the 3GPP, the term “cell” can refer to a coverage area of a network node 110 or a network node subsystem serving such a coverage area, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

As is evident, the wireless network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 102a, the network node 110b may be a pico network node for a pico cell 102b, and the network node 110c may be a femto network node for a femto cell 102c. Various different types of network nodes 110 may generally transmit at different power levels, serve different coverage areas, and/or have different impacts on interference in the wireless network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a UE 120 may implement power saving features, such as for UEs 120 in a radio resource control (RRC) connected mode, an RRC idle mode, or an RRC inactive mode. Power saving features may include, for example, relaxed radio resource monitoring (such as for devices operating in low mobility or in good radio conditions), discontinuous reception (DRX) for latency-tolerant devices, reduced PDCCH monitoring during active times, and/or power-efficient paging reception. For example, a UE 120 may operate in association with a DRX configuration (for example, provided to the UE 120 by a network node 110), which may enable the UE 120 to sleep at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is awake or in an active state, and one or more durations during which the UE 120 may operate in an inactive state, which may be opportunities for the UE 120 to enter a DRX sleep mode in which the UE 120 may refrain from monitoring for communications from a network node 110. The UE 120 may also deactivate antennas, RF chains, and/or other hardware components or devices while operating in the DRX sleep mode. The time during which the UE 120 is configured to be in an active state during a DRX on duration may be referred to as an active time, and the time during which the UE 120 is configured to be in an inactive state such as during a DRX sleep duration may be referred to as an inactive time. During a DRX on duration, the UE 120 may monitor for downlink communications from the network nodes 110. If the UE 120 does not detect and/or successfully decode any downlink communications during the DRX on duration, the UE 120 may enter a DRX sleep mode for the inactive time duration at the end of the DRX on duration. Conversely, if the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. In some examples, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

The network nodes 110 and UEs 120 of the wireless network 100 may communicate using the electromagnetic spectrum, which may be subdivided by frequency or wavelength into various classes, bands, carriers, and/or channels. For example, devices of the wireless network 100 may communicate using one or more operating bands. In some aspects, multiple wireless networks 100 may be deployed in a given geographic area. Each wireless network 100 may support a particular radio access technology (RAT) (which may also be referred to as an air interface) and may operate on one or multiple carrier frequencies in one or multiple frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies in order to avoid interference with one another.

Various operating bands have been defined as frequency range designations FR1 (410 MHz-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHz-300 GHz). Although a portion of FR1 is greater than 6 GHZ, FR1 is often referred to (interchangeably) as a “sub-6 GHz” band in various documents and articles. Accordingly, the term “sub-6 GHZ,” if used herein, may broadly refer to frequencies that may be less than 6 GHZ, may be within FR1, or may include mid-band frequencies. A similar nomenclature issue sometimes occurs in connection with FR2, which is often referred to (interchangeably) as a “millimeter wave” band in documents and articles, despite being different from the extremely high frequency (EHF) band (30 GHZ-300 GHz), which is identified by the International Telecommunications Union (ITU) as a “millimeter wave” band. The frequencies between FR1 and FR2 are often referred to as mid-band frequencies, which include FR3. Accordingly, unless specifically stated otherwise, the term “millimeter wave,” if used herein, may broadly refer to frequencies that may include mid-band frequencies, may be within FR2, FR4, FR4-a or FR4-1, or FR5, or may be within the EHF band. Frequency bands falling within FR3 may inherit FR1 characteristics or FR2 characteristics, and thus may effectively extend features of FR1 or FR2 into mid-band frequencies. Higher frequency bands may extend 5G NR operation, 6G operation, and/or other RATs beyond 52.6 GHZ. For example, each of FR4a, FR4-1, FR4 and FR5 falls within the EHF band. In some examples, wireless network 100 may implement dynamic spectrum sharing (DSS), in which multiple RATs (for example, 4G/LTE and 5G/NR) are implemented with dynamic bandwidth allocation (for example, based on user demand) in a single frequency band. Further, it is contemplated that the frequencies included in these operating bands (for example, FR1, FR2, FR3, FR4, FR4-a, FR4-1, or FR5) may be modified, and techniques described herein may be applicable to those modified frequency ranges.

In some aspects, the UE 120 may include a communication manager 140. As described in more detail elsewhere herein, the communication manager 140 may communicate with a network node to perform a RACH procedure; receive, from the network node prior to commencement or completion of the RACH procedure, information related to a cell DTX/DRX configuration associated with the network node; and monitor, after completion of the RACH procedure, PDCCH occasions starting at or after a beginning of a subsequent cell DTX active time associated with the cell DTX/DRX configuration. Additionally or alternatively, the communication manager 140 may receive, from a network node, information related to a cell DTX configuration associated with multicast/broadcast service (MBS) provided by the network node; and attempt to decode an MTCH starting at or after a beginning of a subsequent cell DTX inactive time associated with the cell DTX configuration. Additionally or alternatively, the communication manager 140 may perform one or more other operations described herein.

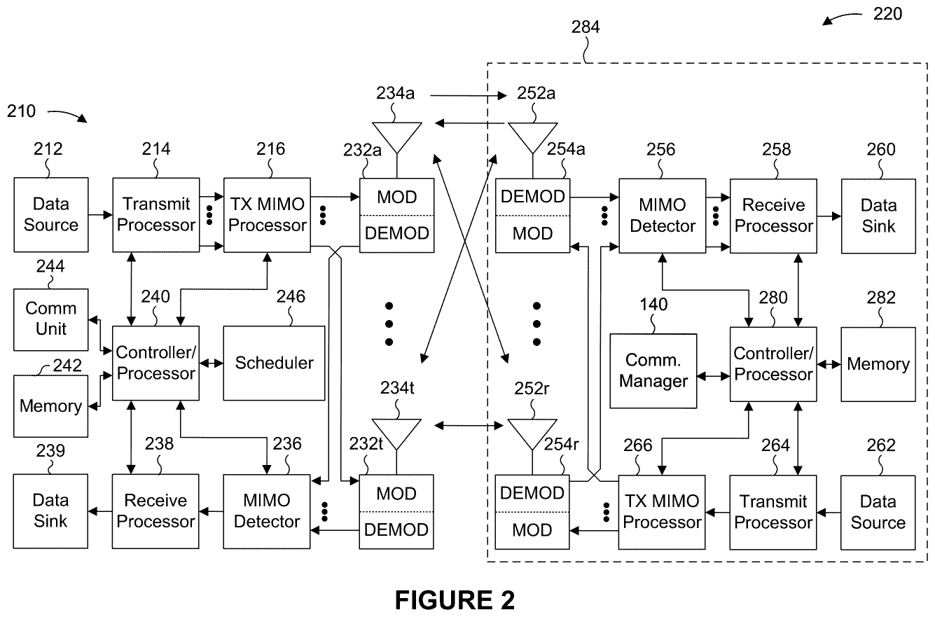

FIG. 2 is a diagram illustrating an example network node 210 in communication with an example UE 220 in a wireless network in accordance with the present disclosure. The network node 210 of FIG. 2 may be an example of the network node 110 described with reference to FIG. 1. Similarly, the UE 220 may be an example of the UE 120 described with reference to FIG. 1.

As shown in FIG. 2, the network node 210 may include a data source 212, a transmit processor 214, a transmit (TX) multiple-input multiple-output (MIMO) processor 216, a set of modems 232 (such as 232a through 232t, where t≥1), a set of antennas 234 (such as 234a through 234t, where t≥1), a MIMO detector 236, a receive processor 238, a data sink 239, a controller/processor 240, a memory 242, a communication unit 244, and/or a scheduler 246, among other examples. In some aspects, one or a combination of the antenna(s) 234, the modem(s) 232, the MIMO detector 236, the receive processor 238, the transmit processor 214, or the TX MIMO processor 216 may be included in a transceiver of the network node 210. The transceiver may be under control of and used by a processor, such as the controller/processor 240, and in some aspects in conjunction with processor-readable code stored in the memory 242, to perform aspects of the methods, processes or operations described herein. The terms “processor,” “controller” or “controller/processor” may refer to one or more controllers and/or one or more processors. For example, reference to “a/the processor” or “a/the controller/processor” (in the singular) should be understood to refer to any one or more of the processors described in connection with FIG. 2 (for example, a single processor or a combination of multiple different processors). Similarly, reference to “a/the memory” should be understood to refer to any one or more memories of the corresponding device or node (for example, a single memory or a combination of multiple different memories). In some aspects, the network node 210 may include one or more interfaces, communication components, or other components that facilitate communication with the UE 220 or another network node.

For downlink communication from the network node 210 to the UE 220, the transmit processor 214 may receive data (“downlink data”) intended for the UE 220 (or a set of UEs that includes the UE 220) from the data source 212 (such as a data pipeline or a data queue). In some examples, the transmit processor 214 may select one or more MCSs for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 214 may process system information (for example, semi-static resource partitioning information (SRPI)) and control information (for example, CQI requests, grants, or upper layer signaling) and provide overhead symbols and control symbols. The transmit processor 214 may generate reference symbols for reference signals (for example, a cell-specific reference signal (CRS), a demodulation reference signal (DMRS), or a channel state information (CSI) reference signal (CSI-RS)) and synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions on the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and control information. The receive processor 238 may provide the decoded data to a data sink 239 (which may be a data pipeline, a data queue, and/or another data sink) and provide the decoded control information to a processor, such as the controller/processor 240.

One or more antennas of the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays.

In some examples, each of the antenna elements of an antenna 234 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, half wavelength, or other fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other so as to generate one or more beams. The term “beam” may, at a basic level, refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, horizontal direction, and/or vertical direction), and/or a set of parameters that indicate one or more aspects of a directional signal, a direction associated with the signal, and/or a set of directional resources associated with the signal. Beamforming includes generation of a beam using multiple signals on different antenna elements, where one or more, or all, of the multiple signals are shifted in phase relative to each other. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the amplitudes and phase shifts or phase offsets of the multiple signals relative to each other.

Different UEs 220 may include different numbers of antenna elements. For example, a UE may include a single antenna element, two antenna elements, four antenna elements, eight antenna elements, or a different number of antenna elements. Generally, a larger number of antenna elements may provide increased control over parameters of beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) is transmitted using a first set of antenna elements and a second layer of a communication (which may include a second data stream) is transmitted using a second set of antenna elements.

The network node 210 may provide the UE 220 with a configuration of transmission configuration indicator (TCI) states that respectively indicate or correspond to beams that may be used by the UE 220, such as for receiving a PDCCH or a PDSCH. For example, the network node 210 may indicate (for example, using DCI) an activated TCI state to the UE 220, which the UE 220 may use to generate a beam for receiving the PDSCH.

A beam indication (an indication of a beam) may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate particular information associated with a beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, and/or qcl-TypeD), a cell identification (for example, a ServCellIndex), a bandwidth part identification (bwp-Id), a reference signal identification such as a CSI-RS identification (for example, an NZP-CSI-RS-Resourceld, and/or an SSB-Index), among other examples. Spatial relation information may similarly indicate information associated with an uplink beam. The beam indication may be a joint or separate downlink/uplink beam indication in a unified TCI framework. In some cases, the network may support a layer 1 (L1)-based beam indication using at least UE-specific (unicast) DCI to indicate joint or separate DL/UL beam indications. In some cases, existing DCI formats 1_1 and/or 1_2 may be reused for beam indication. The network node 210 may include a support mechanism for the UE 220 to acknowledge successful decoding of a beam indication. For example, the acknowledgment/negative acknowledgment of the PDSCH scheduled by the DCI carrying the beam indication may be also used as an ACK for the DCI.

Further efficiencies in throughput, signal strength, and/or other signal properties may be achieved through beam refinement. For example, the network node 210 may be capable of communicating with the UE 220 using beams of various beam widths. For example, the network node 210 may be configured to utilize a wider beam when communicating with the UE 220 when the UE 220 is in motion because of the wider coverage needed to ensure that the UE 220 remains in coverage of the network node 210 when moving. Conversely, the network node 220 may use a narrower beam when communicating with the UE 220 when the UE 220 is stationary because the network node 210 can reliably focus coverage on the UE 220 with low or minimal likelihood of the UE 220 moving out of the coverage area of the network node 210. In some examples, to select a particular beam for communication with a UE 220, the base station may transmit a reference signal, such as a synchronization signal block (SSB) or CSI-RS, on each of a plurality of beams in a beam-sweeping manner. In some examples, SSBs may be transmitted on wider beams, whereas CSI-RSs may be transmitted on narrower beams. The UE 220 may measure a reference signal received power (RSRP) or a signal-to-interference-plus-noise ratio (SINR) on each of the beams and transmit a beam measurement report (for example, a Layer 1 (L1) measurement report) to the network node 210 indicating the RSRP or SINR associated with each of one or more of the measured beams. The network node 210 may then select the particular beam for communication with the UE 220 based on the L1 measurement report. In some other examples, when there is uplink and downlink channel reciprocity, the network node 210 may derive the particular beam to communicate with the UE 220 based on uplink measurements of one or more uplink reference signals, such as an SRS, transmitted by the UE 220.

One enhancement for multi-beam operation at higher carrier frequencies is facilitation of efficient (for example, low latency and low overhead) downlink and/or uplink beam management operations to support higher Layer 1 and/or Layer 2 (L1/L2)-centric inter-cell mobility. L1 and/or L2 signaling may be referred to as “lower layer” signaling and may be used to activate and/or deactivate candidate cells in a set of cells configured for L1/L2 mobility and/or to provide reference signals for measurement by the UE 220, by which the UE 220 may select a candidate beam as a target beam for a lower layer handover operation. Accordingly, one goal for L1/L2-centric inter-cell mobility is to enable a UE to perform a cell switch via dynamic control signaling at lower layers (for example, DCI for L1 signaling or a medium access control (MAC) control element (MAC CE) for L2 signaling), rather than semi-static Layer 3 (L3) RRC signaling, in order to reduce latency, reduce overhead, and/or otherwise increase efficiency of the cell switch.

In some examples, for a UE 220, UL transmission may be performed using one antenna panel, and DL reception may be performed using another antenna panel (for example, to minimize self-interference). In some examples, full-duplex communication may be conditional on a beam separation of the UL beam and DL beam at the respective antenna panels. Utilizing full-duplex communication may provide a reduction in latency, such that it may be possible to receive a DL signal in UL-only slots, which may enable latency savings. In addition, full-duplex communication may enhance spectrum efficiency per cell or per UE 220, and may enable a more efficient utilization of resources. Beam separation of the UL and DL beams assists in limiting or reducing self-interference that may occur during full duplex communication. Determining the UL and DL beams that are separated on their respective antenna panels may provide a reliable full duplex communication by using beam pairs that minimize or reduce self-interference.

A full-duplex UE 220 may perform a self-interference measurement (SIM) procedure in order to identify self-interference from transmissions of the full-duplex UE 220. A full-duplex network node 210 also may perform a SIM procedure in order to identify self-interference from transmissions of the full-duplex network node 210. The UE 220 may provide a measurement report to the network node 210 to indicate results of the UE SIM. The network node 210 may select pairs of beams (referred to herein as “beam pairs”) for the UE (“UE beam pairs”) 220 and the network node (“network node beam pairs”) 210 to use during full-duplex communications. A beam pair generally includes a receive (Rx) beam and a transmit (Tx) beam, such as a DL beam and an UL beam, respectively, for the UE 220, and similarly, an UL beam and a DL beam, respectively, for the network node 210.

The network node 210 may use the scheduler 246 to schedule one or more UEs 220 for downlink or uplink communications. In some aspects, the scheduler 246 may use DCI to dynamically schedule DL transmissions to the UE 220 and/or UL transmissions from the UE 220. In some examples, the scheduler 246 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 214, the TX MIMO processor 216, the modem 232, the antenna 234, the MIMO detector 236, the receive processor 238, and/or the controller/processor 240 may be included in an RF chain of the network node 210. An RF chain may include filters, mixers, oscillators, amplifiers, analog-to-digital converters (ADCs), and/or other devices that convert between an analog signal (such as for transmission or reception on an air interface) and a digital signal (such as for processing by one or more processors of the network node 210). In some aspects, the RF chain may be or may be included in a transceiver of the network node 110.

In some examples, the network node 210 may use the communication unit 244 to communicate with a core network or other network nodes. The communication unit 244 may support wired and/or wireless communication protocols and/or connections such as Ethernet, optical fiber, common public radio interface (CPRI), and/or a wired or wireless backhaul, among other examples. The network node 210 may use the communication unit 244 to transmit and/or receive data associated with the UE 220 or to perform network control signaling, among other examples. The communication unit 244 may include a transceiver and/or an interface such as a network interface.

The UE 220 may include a set of antennas 252 (shown as antennas 252a through 252r, where r≥1), a set of modems 254 (shown as modems 254a through 254r, where r≥ 1), a MIMO detector, a receive processor 258, a data sink 260, a data source 262, a transmit processor 264, a TX MIMO processor 266, a controller/processor 280, a memory 282, and/or a communication manager 140, among other examples. One or more of the components of the UE 220 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 220. The transceiver may be used by a processor (for example, the controller/processor 280) and the memory 282 to perform aspects of any of the methods described herein. The term “controller/processor” may refer to one or more controllers and/or one or more processors. For example, reference to “a/the processor” or “a/the controller/processor” (in the singular) should be understood to refer to any one or more of the processors described in connection with FIG. 2 (for example, a single processor or a combination of multiple different processors). Similarly, reference to “a/the memory” should be understood to refer to any one or more memories of the corresponding device or node (for example, a single memory or a combination of multiple different memories). In some aspects, the UE 220 may include another interface, another communication component, and/or another component that facilitates communication with the network node 210 and/or another UE 220.

One or more antennas of the set of antennas 252 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. In some examples, each of the antenna elements of an antenna 234 may include one or more sub-elements for radiating or receiving radio frequency signals. As used herein, “antenna” can refer to one or more antennas, one or more antenna panels, one or more antenna groups, one or more sets of antenna elements, or one or more antenna arrays.

For downlink communication, the set of antennas 252 may receive the downlink communications or signals from the network node 210 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 220 to a data sink 260 (such as data a data pipeline, a data queue, or an application executed on the UE 220), and may provide decoded control information and system information to a controller/processor 280.

For uplink communication, the transmit processor 264 may receive and process data (“uplink data”) from a data source 262 (such as data a data pipeline, a data queue, or an application executed on the UE 220) and control information from the controller/processor 280. The control information may include one or more parameters, feedback, one or more signal measurements, and/or other types of control information. In some aspects, the receive processor 258 and/or the controller/processor 280 may determine one or more parameters for a received signal (such as received from the network node 210 or another UE), such as a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, and/or another parameter. The control information may facilitate parameter selection and/or scheduling for the UE 220 by the network node 210.

The transmit processor 264 may generate reference symbols for one or more reference signals, such as an uplink DMRS, an uplink SRS, and/or another type of reference signal. The symbols from the transmit processor 264 may be precoded by the TX MIMO processor 266 if applicable, further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, or upconvert) the output sample stream to obtain an uplink signal.

The modems 254a through 254r may transmit a set of uplink signals (for example, R downlink signals) via the corresponding set of antennas 252. An uplink signal may include an uplink control information (UCI) communication, a MAC-CE communication, an RRC communication or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

In some examples, the uplink communication or the downlink communication may include a MIMO communication. “MIMO” generally refers to transmitting and receiving multiple data signals (such as multiple layers or multiple data streams) simultaneously over a radio channel. MIMO may exploit multipath propagation. MIMO may be implemented using spatial processing referred to as precoding, or using spatial multiplexing. In some examples, MIMO may support simultaneous transmission to multiple receivers, referred to as multi-user MIMO (MU-MIMO). Some RATs may employ advanced MIMO techniques, such as multiple TRP operation (including redundant transmission or reception on multiple TRPs), reciprocity in the time domain or the frequency domain, single-frequency-network (SFN) transmission, or non-coherent joint transmission (NC-JT).

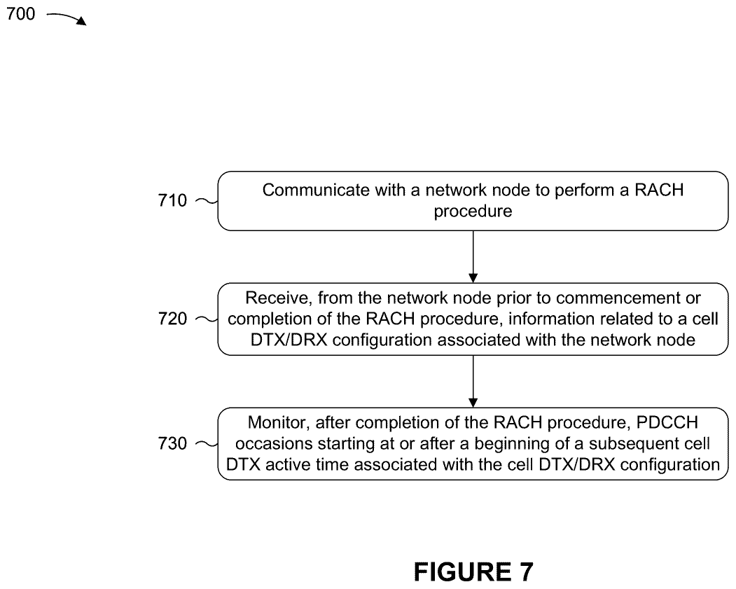

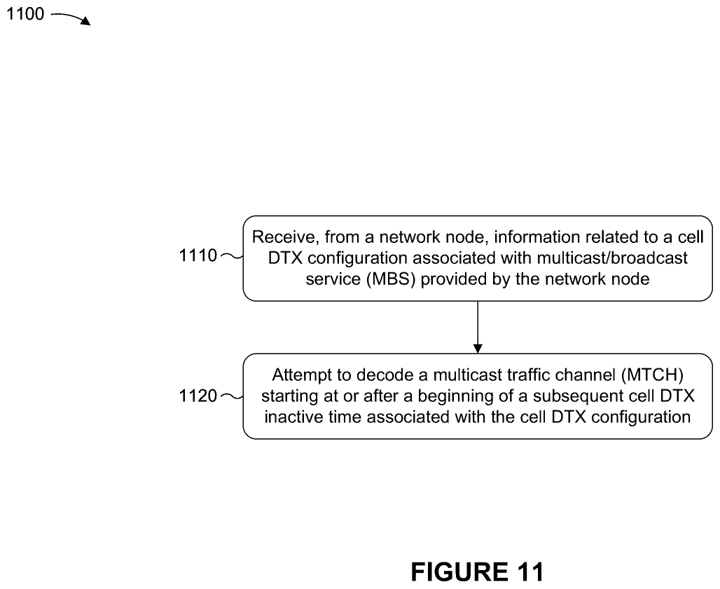

The controller/processor 240 of the network node 210, the controller/processor 280 of the UE 220, or any other component(s) of FIG. 2 may implement one or more techniques or perform one or more operations associated with early cell DTX/DRX signaling, as described in more detail elsewhere herein. For example, the controller/processor 240 of the network node 210, the controller/processor 280 of the UE 220, or any other component(s) of FIG. 2 may perform or direct operations of, for example, process 700 of FIG. 7, process 1100 of FIG. 11, or other processes as described herein. The memory 242 and the memory 282 may store data and program codes for the network node 210 and the UE 220, respectively. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 210 or the UE 220, may cause the one or more processors to perform process 700 of FIG. 7, process 1100 of FIG. 11, or other processes as described herein. In some examples, executing instructions may include running the instructions, converting the instructions, compiling the instructions, or interpreting the instructions, among other examples.

In some aspects, the UE 220 includes means for communicating with a network node 210 to perform a RACH procedure; means for receiving, from the network node 210 prior to commencement or completion of the RACH procedure, information related to a cell DTX/DRX configuration associated with the network node 210; and/or means for monitoring, after completion of the RACH procedure, PDCCH occasions starting at or after a beginning of a subsequent cell DTX active time associated with the cell DTX/DRX configuration. Additionally or alternatively, the UE 220 includes means for receiving, from a network node 210, information related to a cell DTX configuration associated with MBS provided by the network node 210; and/or means for attempting to decode an MTCH starting at or after a beginning of a subsequent cell DTX inactive time associated with the cell DTX configuration. The means for the UE 220 to perform operations described herein may include, for example, one or more of communication manager 140, antenna 252, modem 254, MIMO detector 256, receive processor 258, transmit processor 264, TX MIMO processor 266, controller/processor 280, or memory 282.

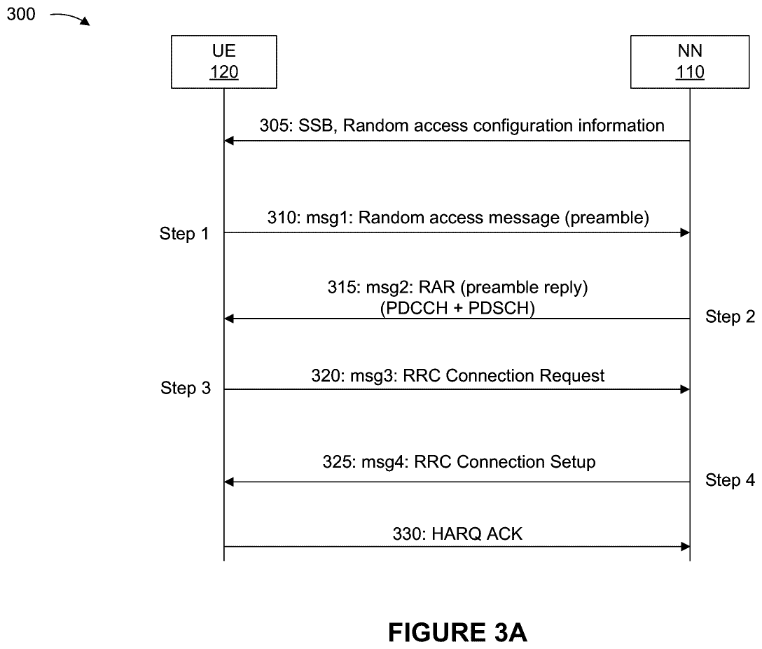

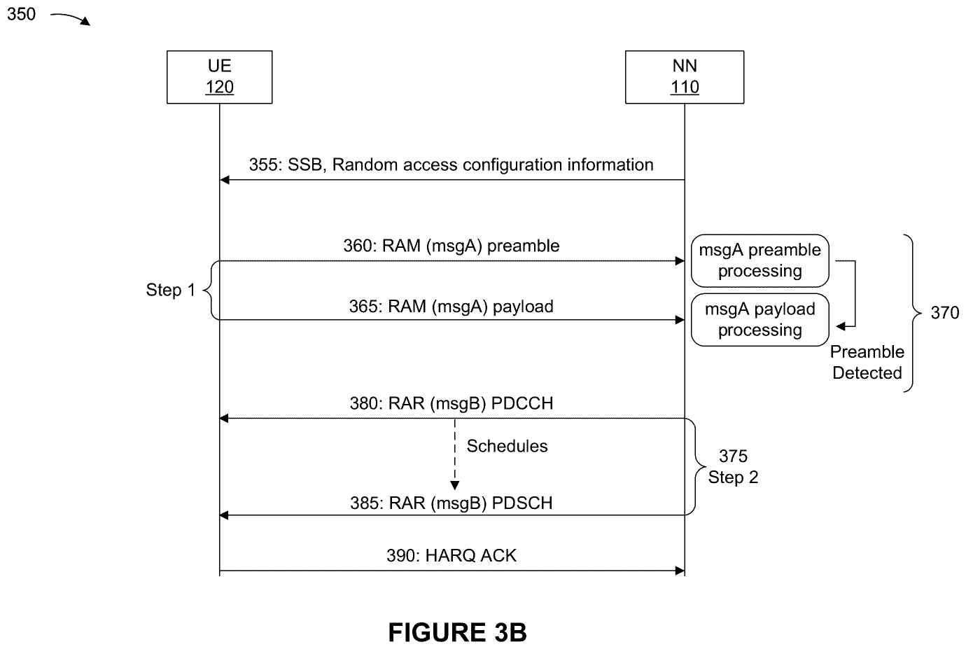

FIGS. 3A-3B are diagrams illustrating examples 300, 350 of RACH procedures in accordance with the present disclosure. In particular, FIG. 3A is a diagram illustrating an example 300 of a four-step RACH procedure, and FIG. 3B is a diagram illustrating an example 350 of a two-step RACH procedure. As shown in FIGS. 3A-3B, a network node 110 and a UE 120 may communicate with one another to perform the four-step RACH procedure or the two-step RACH procedure.

As shown in FIG. 3A, in a first operation 305, the network node 110 may transmit, and the UE 120 may receive, one or more SSBs and random access configuration information. In some aspects, the random access configuration information may be transmitted in and/or indicated by system information (for example, in one or more system information blocks (SIBs)) and/or an SSB, such as for contention-based random access. Additionally or alternatively, the random access configuration information may be transmitted in an RRC message and/or a PDCCH order message that triggers a RACH procedure, such as for contention-free random access. The random access configuration information may include one or more parameters to be used in the four-step RACH procedure, such as one or more parameters for transmitting a random access message (RAM) and/or one or more parameters for receiving a random access response (RAR).

As further shown in FIG. 3A, in a second operation 310, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step RACH procedure. The random access message may include a random access preamble identifier.

As further shown in FIG. 3A, in a third operation 315, the network node 110 may transmit an RAR as a reply to the preamble. The message that includes the RAR may be referred to as message 2, msg2, MSG2, or a second message in the four-step RACH procedure. In some aspects, the RAR may indicate the detected random access preamble identifier (for example, received from the UE 120 in msg1). Additionally or alternatively, the RAR may indicate a resource allocation to be used by the UE 120 to transmit message 3 (msg3).

In some aspects, as part of the second step of the four-step RACH procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step RACH procedure, the network node 110 may transmit the PDSCH communication for the RAR, as scheduled by the PDCCH communication. The RAR may be included in a MAC protocol data unit (PDU) of the PDSCH communication.

As further shown in FIG. 3A, in a fourth operation 320, the UE 120 may transmit an RRC connection request message. The RRC connection request message may be referred to as message 3, msg3, MSG3, or a third message of the four-step RACH procedure. In some aspects, the RRC connection request may include a UE identifier, UCI, and/or a PUSCH communication (for example, an RRC connection request).

As further shown in FIG. 3A, in a fifth operation 325, the network node 110 may transmit an RRC connection setup message. The RRC connection setup message may be referred to as message 4, msg4, MSG4, or a fourth message of the four-step RACH procedure. In some aspects, the RRC connection setup message may include the detected UE identifier, a timing advance value, and/or contention resolution information. As further shown in FIG. 3A, in a sixth operation 330, if the UE 120 successfully receives the RRC connection setup message, the UE 120 may transmit a hybrid automatic repeat request (HARQ) acknowledgement (ACK).

Additionally or alternatively, as shown in FIG. 3B, in a first operation 355, the network node 110 may transmit, and the UE 120 may receive, one or more SSBs and random access configuration information. In some aspects, the random access configuration information may be transmitted in and/or indicated by system information (for example, in one or more SIBs) and/or an SSB, such as for contention-based random access. Additionally or alternatively, the random access configuration information may be transmitted in an RRC message and/or a PDCCH order message that triggers a RACH procedure, such as for contention-free random access. The random access configuration information may include one or more parameters to be used in the two-step RACH procedure, such as one or more parameters for transmitting a RAM and/or receiving a RAR to the RAM.

As further shown in FIG. 3B, in a second operation 360, the UE 120 may transmit, and the network node 110 may receive, a RAM preamble. As shown in FIG. 3B, in a third operation 365, the UE 120 may transmit, and the network node 110 may receive, a RAM payload. As shown, the UE 120 may transmit the RAM preamble and the RAM payload to the network node 110 as part of an initial (or first) step of the two-step RACH procedure. In some aspects, the RAM may be referred to as message A, msgA, a first message, or an initial message in a two-step RACH procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of the four-step RACH procedure described in more detail above with reference to FIG. 3A. For example, the RAM preamble may include some or all contents of message 1 (for example, a PRACH preamble), and the RAM payload may include some or all contents of message 3 (for example, a UE identifier, UCI, and/or a PUSCH transmission).

As shown in FIG. 3B, in a fourth operation 370, the network node 110 may receive the RAM preamble transmitted by the UE 120. If the network node 110 successfully receives and decodes the RAM preamble, the network node 110 may then receive and decode the RAM payload.

As shown in FIG. 3B, in a fifth operation 375, the network node 110 may transmit an RAR (sometimes referred to as an RAR message). As shown, the network node 110 may transmit the RAR message as part of a second step of the two-step RACH procedure. In some aspects, the RAR message may be referred to as message B, msgB, or a second message in a two-step RACH procedure. The RAR message may include some or all of the contents of message 2 (msg2) and message 4 (msg4) of the four-step RACH procedure described above with reference to FIG. 3A. For example, the RAR message may include the detected PRACH preamble identifier, the detected UE identifier, a timing advance value, and/or contention resolution information.

As shown in FIG. 3B, in a sixth operation 380, as part of the second step of the two-step RACH procedure, the network node 110 may transmit a PDCCH communication for the RAR. The PDCCH communication may schedule a PDSCH communication that includes the RAR. For example, the PDCCH communication may indicate a resource allocation (for example, in DCI) for the PDSCH communication.

As shown in FIG. 3B, in a seventh operation 385, as part of the second step of the two-step RACH procedure, the network node 110 may transmit the PDSCH communication for the RAR, as scheduled by the PDCCH communication. The RAR may be included in a MAC PDU of the PDSCH communication. As shown in FIG. 3B, in an eighth operation 390, if the UE 120 successfully receives the RAR, the UE 120 may transmit a HARQ ACK.

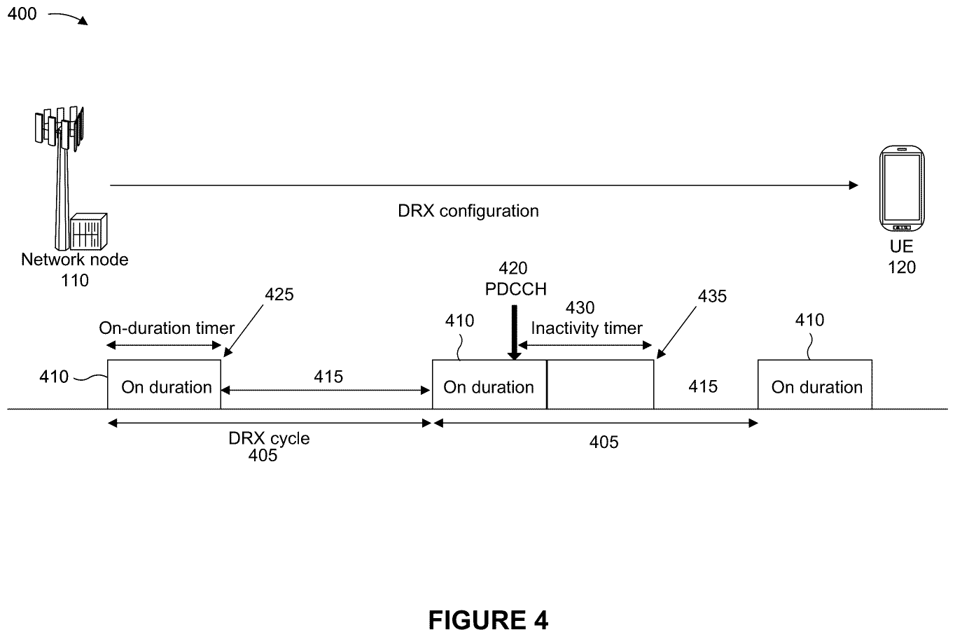

FIG. 4 is a diagram illustrating an example 400 of a DRX configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (for example, during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a PDCCH during the active time, and may refrain from monitoring the PDCCH during the inactive time.

During the DRX on duration 410 (for example, the active time), the UE 120 may perform a monitoring operation 420 to monitor a downlink control channel (for example, a PDCCH). For example, the UE 120 may monitor the PDCCH for DCI pertaining to the UE 120. If the UE 120 does not detect and/or successfully decode any PDCCH communications intended for the UE 120 during the DRX on duration 410, then the UE 120 may perform a sleep operation 425 and enter the sleep state 415 (for example, for the inactive time) at the end of the DRX on duration 410. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (for example, awake) for the duration of a DRX inactivity timer 430 (for example, which may extend the active time). The UE 120 may start the DRX inactivity timer 430 at a time at which the PDCCH communication is received (for example, in a TTI in which the PDCCH communication is received, such as a slot or a subframe). The UE 120 may remain in the active state until the DRX inactivity timer 430 expires, at which time the UE 120 may perform a sleep operation 435 and enter the sleep state 415 (for example, for the inactive time). During the duration of the DRX inactivity timer 430, the UE 120 may continue to monitor for PDCCH communications, may obtain a downlink data communication (for example, on a downlink data channel, such as a PDSCH) scheduled by the PDCCH communication, and/or may prepare and/or transmit an uplink communication (for example, on a PUSCH) scheduled by the PDCCH communication. The UE 120 may restart the DRX inactivity timer 430 after each detection of a PDCCH communication for the UE 120 for an initial transmission (for example, but not for a retransmission). By operating in this manner, the UE 120 may conserve battery power and reduce power consumption by entering the sleep state 415.

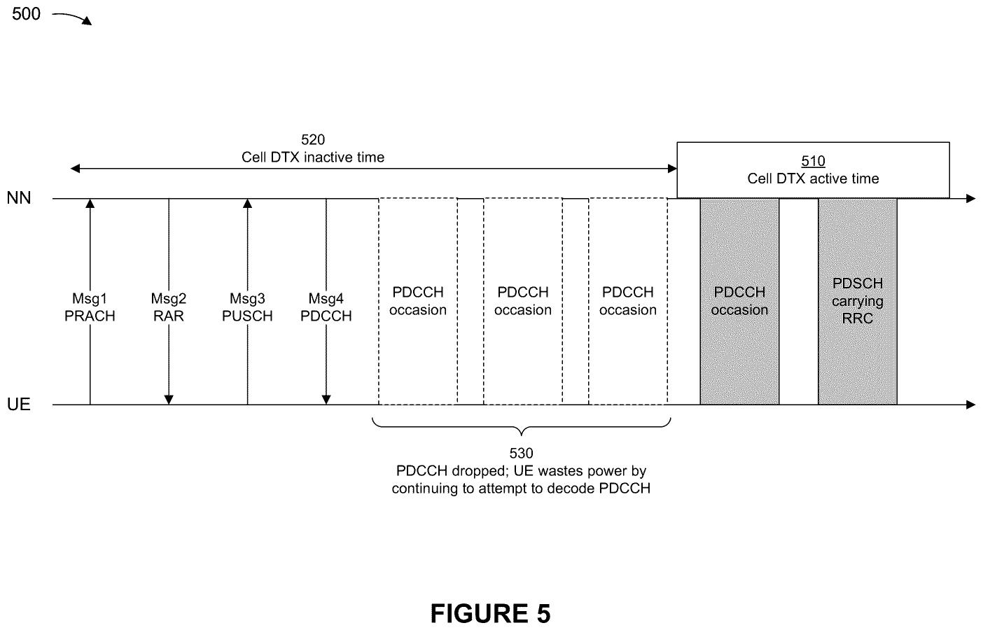

FIG. 5 is a diagram illustrating an example 500 of wasted power at a UE performing a RACH procedure with a network node operating according to a cell DTX/DRX configuration in accordance with the present disclosure.

For various reasons, including climate change mitigation, environmental sustainability, and network cost reduction, network energy saving and/or network energy efficiency measures are expected to have increased importance in wireless network operations. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, which could potentially lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network. The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are important factors that may drive adoption and/or expansion of wireless networks.

For example, one potential technique to increase energy efficiency in a RAN may be to enable a cell DTX/DRX configuration, which may generally have similar characteristics as a DRX configuration that may be configured for a UE. For example, a cell DTX/DRX configuration may include a DTX/DRX active time 510, during which a network node transmits and/or receives one or more channels or signals, and an opportunity for a network node to enter a sleep state during an inactive time 520 (for example, a non-active duration) when an entire cell (for example, including the network node and any connected mode UEs) is asleep. For example, the cell DTX/DRX configuration may be achieved by aligning DRX configurations associated with connected mode UEs via network implementation (for example, aligning the DRX on duration for each connected mode UE) such that the network node can enter a sleep state when all connected mode UEs are in a sleep state and communicate with connected mode UEs when all connected mode UEs are awake during the aligned DRX on durations.

In general, as described herein, the network node does not transmit various downlink channels or downlink messages during the inactive time 520 of the cell DTX/DRX cycle, to conserve power. However, the network node does not drop all downlink transmissions during the inactive time 520 of the cell DTX/DRX cycle. For example, in some aspects, the network node does not drop system information (SI) transmissions, paging messages, and/or any RACH messages during the inactive time 520 of the cell DTX/DRX cycle (for example, a UE may perform a RACH procedure and receive SIB transmissions during the inactive time 520 of the cell DTX/DRX cycle). This may lead to wasted power consumption, however, in cases where a UE needs to perform a RACH procedure during a time period that at least partially overlaps with the inactive time 520 of the cell DTX/DRX cycle. For example, the cell DTX/DRX configuration associated with a network node is generally cell-specific, and configured via unicast RRC signaling that is transmitted to a UE when the UE is in an RRC connected state. Accordingly, in cases where a UE communicates with a network node to perform a RACH procedure (for example, to obtain initial access to a cell provided by the network node or to transition from an RRC idle or inactive state to an RRC connected state when the UE has uplink data to transmit or a paging message informs the UE that there is downlink data available for the UE), the UE may be unaware of the cell DTX/DRX configuration (if any) that is being used by the network node at the time that the RACH procedure is completed.

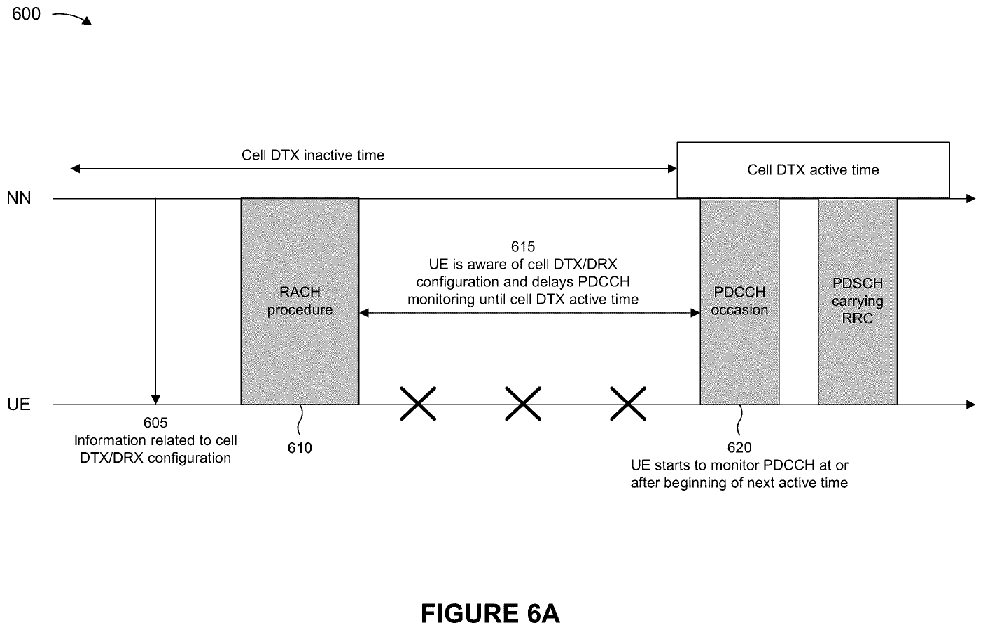

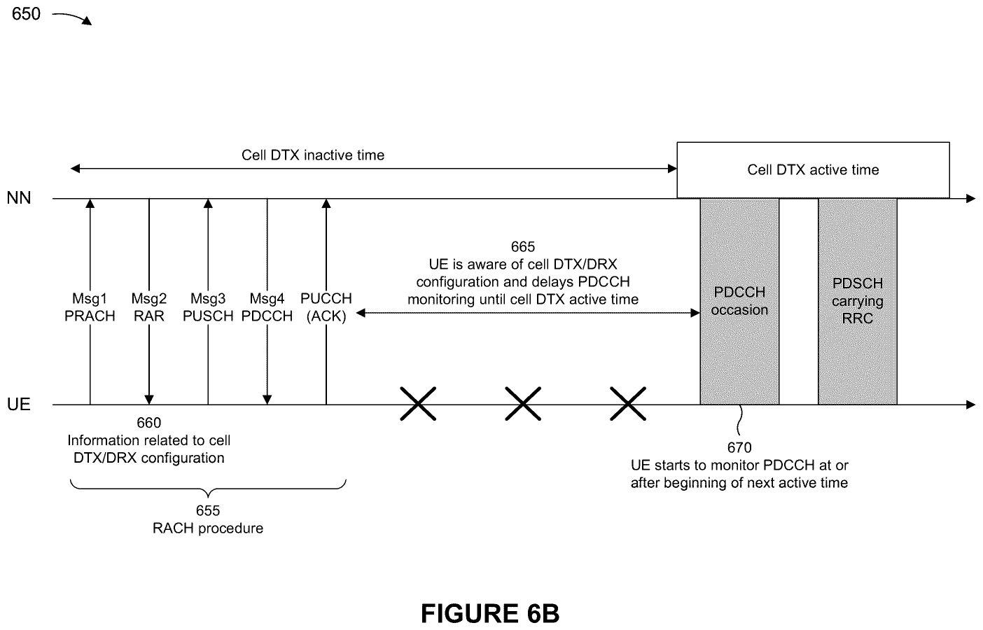

As a result, after the RACH procedure is completed, the UE may have to wait a significant amount of time to receive a PDCCH or PDSCH that carries the unicast RRC signaling indicating the cell DTX/DRX configuration, and the UE generally continues to monitor PDCCH occasions during the inactive time 520 of the cell DTX/DRX cycle. For example, FIG. 5 illustrates a scenario where a UE performs a four-step RACH procedure to enter an RRC connected state in a cell provided by a network node during the inactive time 520 of a cell DTX/DRX cycle. However, some aspects described herein similarly apply to a two-step RACH procedure. As shown, the network node continues to receive and transmit RACH messages from the UE during the inactive time of the cell DTX/DRX cycle. However, during the inactive time 520 of the cell DTX/DRX cycle, the network node drops (for example, does not transmit) PDCCH messages in one or more PDCCH occasions 530 that occur during the inactive time 520 of the cell DTX/DRX cycle. As a result, because the UE is unaware of the cell DTX/DRX configuration, the UE wastes power monitoring the one or more PDCCH occasions 530 that occur during the inactive time 520 of the cell DTX/DRX cycle even though the network node is not transmitting any PDCCH messages in the monitored PDCCH occasion(s) 530 that coincide with the inactive time 520 of the cell DTX/DRX cycle. Accordingly, as described in further detail herein with respect to FIGS. 6A-6B, some aspects relate to signaling information related to the cell DTX/DRX configuration to a UE prior to or during a RACH procedure such that the UE may delay monitoring PDCCH occasions after the RACH procedure is complete until a next active time associated with the cell DTX/DRX cycle.

FIGS. 6A-6B are diagrams illustrating examples 600 and 650 of early cell DTX/DRX signaling in accordance with the present disclosure. As shown in FIGS. 6A-6B, examples 600 and 650 include communication between a network node (for example, network node 110 or 210) and a UE (for example, UE 120 or 220). In some aspects, the network node and the UE may communicate in a wireless network, such as wireless network 100. The network node and the UE may communicate via a wireless access link, which may include an uplink and a downlink.

As shown in FIG. 6A, in a first operation 605, the network node may transmit and the UE may receive, information related to a cell DTX/DRX configuration and activation information associated with the cell DTX/DRX configuration. For example, as described herein, the cell DTX/DRX configuration may include a cell DTX active time during which the network node is transmitting system information, paging messages, RACH messages, PDCCH messages, PDSCH messages, downlink reference signals, and/or other downlink channels or signals. In addition, the cell DTX/DRX configuration may include a cell DTX inactive time during which the network node is transmitting only system information, paging messages, and RACH messages (for example, PDCCH messages, PDSCH messages, downlink reference signals, and/or other downlink channels or signals are dropped during the cell DTX inactive time).

Accordingly, as shown in FIG. 6A, the information related to a cell DTX/DRX configuration and activation information associated with the cell DTX/DRX configuration may be received by the UE before the UE commences a RACH procedure, whereby the UE is aware of the cell DTX/DRX configuration and the associated activation information before starting the RACH procedure. For example, in some aspects, the network node may provide a current serving cell for the UE, and the information related to the cell DTX/DRX configuration may include a same-cell indication of the cell DTX/DRX configuration that is provided in a SIB (for example, SIB1). For example, in some aspects, SIB1 may indicate the cell DTX/DRX configuration only, and the activation information (for example, an activation state or activation time of the cell DTX/DRX configuration) may be indicated in a downlink message of the RACH procedure (for example, msg2 or msg4 of a four-step RACH procedure, or msgB of a two-step RACH procedure). Alternatively, in some aspects, SIB1 may indicate the cell DTX/DRX configuration and the activation state or activation time of the cell DTX/DRX configuration. Additionally or alternatively, SIB1 may be used to indicate multiple candidate cell DTX/DRX configurations, and an active cell DTX/DRX configuration may be indicated in SIB1 or dynamically in a downlink message of the RACH procedure. Furthermore, in some aspects, SIB1 may carry information that indicates whether one or more uplink and/or downlink restrictions are applied during the inactive time of the cell DTX/DRX configuration such that the UE can avoid wasting power transmitting a sounding reference signal (SRS) or other uplink messages during the inactive time of the cell DTX/DRX configuration.

Additionally or alternatively, the network node may signal the information related to the cell DTX/DRX configuration for one or more neighbor cells in a SIB that carries information related to intra-frequency and/or inter-frequency neighbor cells. For example, in some aspects, the cell DTX/DRX configurations for each intra-frequency and/or inter-frequency neighbor cell may be signaled or otherwise indicated in SIB2, SIB3, SIB4, or another suitable SIB. In this case, the UE may become aware of the cell DTX/DRX configuration for a neighbor cell before commencing or otherwise initiating a RACH procedure in a neighbor cell. However, the UE may be unaware of whether the cell DTX/DRX configuration of the neighbor cell is active based on the cell DTX/DRX configuration signaled in the SIB(s) carrying the information related to the intra-frequency and/or inter-frequency neighbor cells (for example, because the cell DTX/DRX configuration may change between a first time when the UE acquires the SIB carrying the cell DTX/DRX configuration for the neighbor cell and a second time when the UE attempts a RACH procedure in the neighbor cell). Accordingly, in some aspects, a SIB carrying a cell DTX/DRX configuration for a neighbor cell may further indicate a time-to-expire, which may define a time when the UE may assume that the cell DTX/DRX configuration is active for the neighbor cell.

Additionally or alternatively, the information related to the cell DTX/DRX configuration may include a same-cell indication of the cell DTX/DRX configuration and the associated activation state, which may be signaled in a paging message directed to the UE (for example, in a short message field of the paging message). In this example, the paging message may include a set of bits (for example, eight bits) to indicate a time delay until the UE can decode a PDCCH. For example, in some aspects, the time delay may be indicated as a number of time units (for example, a number of milliseconds), or as a number of symbols from a PRACH occasion to a next cell DTX active time. In cases where the time delay is indicated as a number of symbols from a PRACH occasion to a next cell DTX active time, the UE may derive the duration of the time (for example, in time units, such as milliseconds or seconds) based on a BWP. For example, each symbol may have a duration that depends on a subcarrier spacing (SCS) associated with a BWP, where a larger SCS generally corresponds to a shorter symbol duration and a smaller SCS corresponds to a longer symbol duration. Accordingly, the UE may determine the time delay until the next cell DTX active time based on the number of symbols indicated in the paging message and the SCS associated with a particular BWP, such as an initial uplink BWP, an initial downlink BWP, an active uplink/downlink BWP, or a BWP that is configured for the UE for delay determination purposes.

Additionally or alternatively, the information related to the cell DTX/DRX configuration may include a reference time that indicates when the UE is to start monitoring a PDCCH. For example, because the cell DTX/DRX configuration may be activated or deactivated by Layer 1 (L1) signaling, the network node may indicate the reference time when the UE is to start monitoring the PDCCH (e.g., in one or more UE-specific search space sets or in a common search space set). In some aspects, the reference time when the UE starts to monitor the PDCCH may be in the active time or the inactive time of the cell DTX/DRX configuration.

Accordingly, in the example 600 shown in FIG. 6A, the UE generally becomes aware of the cell DTX/DRX configuration and the associated activation state or activation time of the cell DTX/DRX configuration before communicating with the network node to perform a RACH procedure in operation 610. Alternatively, in some aspects, the UE may become aware of only the cell DTX/DRX configuration before communicating with the network node to perform a RACH procedure in operation 610, and may become aware of the associated activation state or activation time of the cell DTX/DRX configuration while performing the RACH procedure. For example, as described herein, the RACH procedure may include a four-step RACH procedure or a two-step RACH procedure, and the network node may dynamically signal one or more parameters related to the cell DTX/DRX configuration in a downlink message of the RACH procedure (for example, msg2 or msg4 of a four-step RACH procedure, or msgB of a two-step RACH procedure). For example, the dynamically signaled parameters may include the activation state or activation time of the cell DTX/DRX configuration, an indication of an active cell DTX/DRX pattern where multiple candidate cell DTX/DRX configurations are supported, and/or whether and which uplink and/or downlink channel restrictions are applicable during the inactive time of the cell DTX/DRX configuration. Alternatively, in some aspects, a default configuration may indicate that uplink and/or downlink channel restrictions are always applied during the inactive time of the cell DTX/DRX configuration or that uplink and/or downlink channel restrictions are always inapplicable during the inactive time of the cell DTX/DRX configuration. For example, in some aspects, the default configuration may be indicated in system information or a wireless communication standard, or the default configuration may be indicated in a downlink message of the RACH procedure (for example, in cases where the cell DTX/DRX configuration is indicated in the same RACH procedure or a SIB). In general, the default configuration for the uplink or downlink channel restrictions may remain in effect until the UE receives a new L1 or L2 indication that carries information related to activating a cell DTX/DRX configuration.

Accordingly, in a third operation 615, after the RACH procedure is complete, the UE is aware of the cell DTX/DRX configuration and delays listening for or otherwise monitoring PDCCH occasions that coincide with the cell DTX/DRX inactive time. In particular, the UE refrains from monitoring the PDCCH occasions that occur during the inactive time of the cell DTX/DRX inactive time, and delays PDCCH monitoring until the next cell DTX active time. In this way, the UE conserves power that would have otherwise been wasted by monitoring PDCCH occasions in which the network node will not be transmitting PDCCH messages. Furthermore, in cases where one or more uplink and/or downlink channel restrictions are in effect during the inactive time of the cell DTX/DRX configuration, the UE may refrain from transmitting the restricted uplink channels and/or monitoring the restricted downlink channels during the inactive time of the cell DTX/DRX configuration, to save power. As shown, in a fourth operation 620, the UE may start to monitor the PDCCH occasions at or after the beginning of the next active time associated with the cell DTX/DRX configuration. Additionally or alternatively, in cases where one or more uplink and/or downlink channel restrictions are in effect during the inactive time of the cell DTX/DRX configuration, the UE may transmit the uplink channels and/or monitor the downlink channels starting at or after the beginning of the next active time associated with the cell DTX/DRX configuration. In this way, the UE may transmit uplink channels or signals only during time periods when the network node is listening for the uplink channels or signals, and may monitor downlink channels or signals only during time periods when the network node is transmitting the downlink channels or signals.

Additionally or alternatively, referring to FIG. 6B, example 650 illustrates a scenario where the UE becomes aware of the cell DTX/DRX configuration and associated activation state or activation time during a RACH procedure. For example, in a first operation 655, the UE communicates with the network node to perform a RACH procedure, which is shown as a four-step RACH procedure in FIG. 6B. However, the techniques described herein may be similarly applied to a two-step RACH procedure. As further shown, in a second operation 660 that occurs during the RACH procedure, the network node may transmit, and the UE may receive, information that indicates a cell DTX/DRX configuration and a time delay until the inactive time of the cell DTX/DRX configuration. For example, the information that indicates a cell DTX/DRX configuration and a time delay until the inactive time of the cell DTX/DRX configuration may be indicated in a downlink message of the RACH procedure, such as msg2 or msg4 of a four-step RACH procedure or msgB of a two-step RACH procedure. In some aspects, in cases where the cell DTX/DRX configuration and the time delay until the inactive time of the cell DTX/DRX configuration are indicated during the RACH procedure, the time delay may be from a symbol in which the UE transmits a PUCCH message to acknowledge successful reception of a final message of the RACH procedure (for example, msg4 of a four-step RACH procedure or msgB of a two-step RACH procedure). Furthermore, the time delay until the inactive time of the cell DTX/DRX configuration may be indicated as a number of time units (for example, a number of milliseconds), or as a number of transmission time intervals (for example, a number of symbols). In cases where the time delay is indicated as a number of transmission time intervals, the SCS that is used to determine the duration of the time delay may be an SCS associated with an initial uplink BWP, an SCS associated with an initial downlink BWP, an SCS associated with an active uplink/downlink BWP, or an SCS associated with a BWP that is configured for the UE for delay determination purposes.

Accordingly, in example 650 in FIG. 6B, the UE generally becomes aware of the cell DTX/DRX configuration and the time delay until the inactive time of the cell DTX/DRX configuration while communicating with the network node to perform a RACH procedure. Furthermore, as described herein, the network node may dynamically signal one or more parameters related to the cell DTX/DRX configuration in a downlink message of the RACH procedure (for example, msg2 or msg4 of a four-step RACH procedure, or msgB of a two-step RACH procedure). For example, the dynamically signaled parameters may include the activation state or activation time of the cell DTX/DRX configuration, an indication of an active cell DTX/DRX pattern where multiple candidate cell DTX/DRX configurations are supported, and/or whether and which uplink and/or downlink channel restrictions are applicable during the inactive time of the cell DTX/DRX configuration. Alternatively, in some aspects, a default configuration may indicate that uplink and/or downlink channel restrictions are always applied during the inactive time of the cell DTX/DRX configuration or that uplink and/or downlink channel restrictions are always inapplicable during the inactive time of the cell DTX/DRX configuration. For example, in some aspects, the default configuration may be indicated in system information or a wireless communication standard, or the default configuration may be indicated in a downlink message of the RACH procedure (for example, in cases where the cell DTX/DRX configuration is indicated in the same RACH procedure or a SIB). In general, the default configuration for the uplink or downlink channel restrictions may remain in effect until the UE receives a new L1 or L2 indication that carries information related to activating a cell DTX/DRX configuration.

Accordingly, in a third operation 665, after the RACH procedure is complete, the UE is aware of the cell DTX/DRX configuration and delays listening for or otherwise monitoring PDCCH occasions that coincide with the cell DTX/DRX inactive time. In particular, the UE refrains from monitoring the PDCCH occasions that occur during the inactive time of the cell DTX/DRX inactive time, and delays PDCCH monitoring until the next cell DTX active time. In this way, the UE conserves power that would have otherwise been wasted by monitoring PDCCH occasions in which the network node will not be transmitting PDCCH messages. Furthermore, in cases where one or more uplink and/or downlink channel restrictions are in effect during the inactive time of the cell DTX/DRX configuration, the UE may refrain from transmitting the restricted uplink channels and/or monitoring the restricted downlink channels during the inactive time of the cell DTX/DRX configuration to save power. As shown, in a fourth operation 670, the UE may start to monitor the PDCCH occasions at or after the beginning of the next active time associated with the cell DTX/DRX configuration. Additionally or alternatively, in cases where one or more uplink and/or downlink channel restrictions are in effect during the inactive time of the cell DTX/DRX configuration, the UE may transmit the uplink channels and/or monitor the downlink channels starting at or after the beginning of the next active time associated with the cell DTX/DRX configuration. In this way, the UE may save power by transmitting uplink channels or signals only during time periods when the network node is listening for the uplink channels or signals, and by monitoring downlink channels or signals only during time periods when the network node is transmitting the downlink channels or signals.

FIG. 7 is a flowchart illustrating an example process 700 performed, for example, by a UE that supports early cell DTX/DRX signaling in accordance with the present disclosure. Example process 700 is an example where the UE (for example, UE 120 or UE 220) performs operations associated with early cell DTX/DRX signaling.

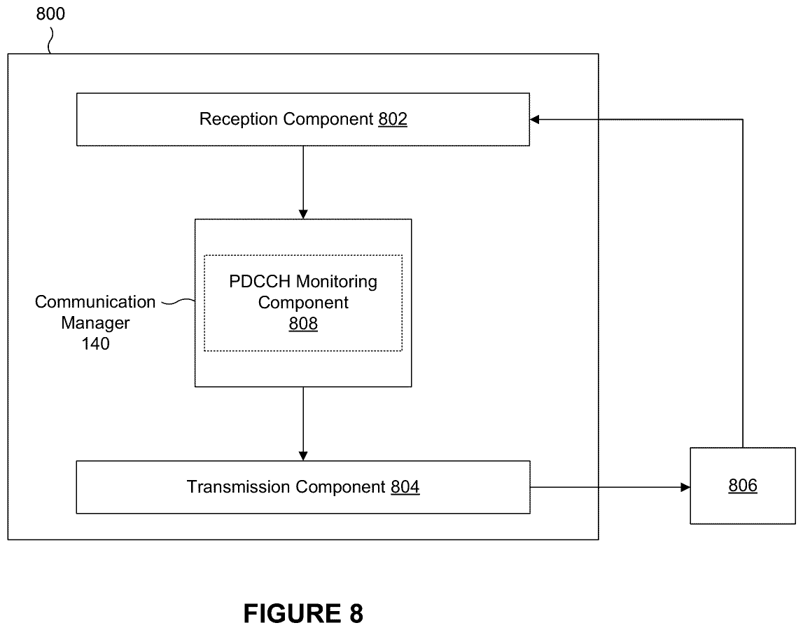

As shown in FIG. 7, in some aspects, process 700 may include communicating with a network node to perform a RACH procedure (block 710). For example, the UE (such as by using communication manager 140, reception component 802, or transmission component 804, depicted in FIG. 8) may communicate with a network node to perform a RACH procedure, as described above.

As further shown in FIG. 7, in some aspects, process 700 may include receiving, from the network node prior to commencement or completion of the RACH procedure, information related to a cell DTX/DRX configuration associated with the network node (block 720). For example, the UE (such as by using communication manager 140 or reception component 802, depicted in FIG. 8) may receive, from the network node prior to commencement or completion of the RACH procedure, information related to a cell DTX/DRX configuration associated with the network node, as described above.

As further shown in FIG. 7, in some aspects, process 700 may include monitoring, after completion of the RACH procedure, PDCCH occasions starting at or after a beginning of a subsequent cell DTX active time associated with the cell DTX/DRX configuration (block 730). For example, the UE (such as by using communication manager 140 or PDCCH monitoring component 808, depicted in FIG. 8) may monitor, after completion of the RACH procedure, PDCCH occasions starting at or after a beginning of a subsequent cell DTX active time associated with the cell DTX/DRX configuration, as described above.

Process 700 may include additional aspects, such as any single aspect or any combination of aspects described below or in connection with one or more other processes described elsewhere herein.

In a first additional aspect, the cell DTX/DRX configuration is associated with a current serving cell associated with the network node, the RACH procedure is performed with the current serving cell, and the information related to the cell DTX/DRX configuration is received in a SIB that indicates an activation state or activation time for the cell DTX/DRX configuration, the SIB being received prior to the commencement of the RACH procedure.

In a second additional aspect, alone or in combination with the first aspect, the cell DTX/DRX configuration is associated with a neighbor cell associated with the network node, the RACH procedure is performed with the neighbor cell, and the information related to the cell DTX/DRX configuration is received in a SIB that indicates a time-to-expire for the cell DTX/DRX configuration, the SIB being received prior to the commencement of the RACH procedure.

In a third additional aspect, alone or in combination with one or more of the first and second aspects, the cell DTX/DRX configuration is associated with a current serving cell associated with the network node, the RACH procedure is performed with the current serving cell, and the information related to the cell DTX/DRX configuration is received in a paging message that indicates an activation state for the cell DTX/DRX configuration, the paging message being received prior to the commencement of the RACH procedure.

In a fourth additional aspect, alone or in combination with one or more of the first through third aspects, the information related to the cell DTX/DRX configuration includes a reference time when the UE is to start to monitor the PDCCH occasions.

In a fifth additional aspect, alone or in combination with one or more of the first through fourth aspects, the information related to the cell DTX/DRX configuration is received during the RACH procedure in a downlink message indicating a time delay until the subsequent cell DTX active time.

In a sixth additional aspect, alone or in combination with one or more of the first through fifth aspects, process 700 includes transmitting, to the network node, a PUCCH message to acknowledge a final downlink message associated with the RACH procedure, and the time delay starts from a symbol in which the PUCCH message is transmitted.

In a seventh additional aspect, alone or in combination with one or more of the first through sixth aspects, the time delay is indicated as a number of symbols associated with an SCS.

In an eighth additional aspect, alone or in combination with one or more of the first through seventh aspects, the time delay is indicated as a number of time units.

In a ninth additional aspect, alone or in combination with one or more of the first through eighth aspects, process 700 includes transmitting, after completion of the RACH procedure, one or more uplink signals starting at or after the beginning of the subsequent cell DRX active time in accordance with an indication of whether a default uplink or downlink channel restriction is applicable during an inactive time associated with the cell DTX/DRX configuration.

In a tenth additional aspect, alone or in combination with one or more of the first through ninth aspects, process 700 includes receiving, during the RACH procedure, the indication of whether the default uplink or downlink channel restriction is applicable during the inactive time associated with the cell DTX/DRX configuration.

In an eleventh additional aspect, alone or in combination with one or more of the first through tenth aspects, the information related to the cell DTX/DRX configuration is received in a SIB prior to the commencement of the RACH procedure, and communicating with the network node to perform the RACH procedure includes receiving a message that indicates an activation state or an activation time for the cell DTX/DRX configuration during the RACH procedure.

In a twelfth additional aspect, alone or in combination with one or more of the first through eleventh aspects, the information related to the cell DTX/DRX configuration includes a SIB that indicates multiple candidate cell DTX/DRX configurations, and communicating with the network node to perform the RACH procedure includes receiving, during the RACH procedure, a message that indicates, among the multiple candidate cell DTX/DRX configurations, an active cell DTX/DRX configuration.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports early cell DTX/DRX signaling in accordance with the present disclosure. The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIGS. 6A-6B. Additionally or alternatively, the apparatus 800 may be configured to and/or operable to perform one or more processes described herein, such as process 700 of FIG. 7. In some aspects, the apparatus 800 may include one or more components of the UE described above in connection with FIG. 2.

The reception component 802 may receive communications, such as reference signals, control information, and/or data communications, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a modem, a demodulator, a MIMO detector, a receive processor, a controller/processor, and/or a memory of the UE described above in connection with FIG. 2.

The transmission component 804 may transmit communications, such as reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, and/or a memory of the UE described above in connection with FIG. 2. In some aspects, the transmission component 804 may be co-located with the reception component 802 in a transceiver.

The communication manager 140 may communicate with a network node to perform a RACH procedure. The communication manager 140 may receive or may cause the reception component 802 to receive, from the network node prior to commencement or completion of the RACH procedure, information related to a cell DTX/DRX configuration associated with the network node. The communication manager 140 may monitor, after completion of the RACH procedure, PDCCH occasions starting at or after a beginning of a subsequent cell DTX active time associated with the cell DTX/DRX configuration. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as a PDCCH monitoring component 808. Alternatively, the set of components may be separate and distinct from the communication manager 140. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 and the transmission component 804 may communicate with a network node to perform a RACH procedure. The reception component 802 may receive, from the network node prior to commencement or completion of the RACH procedure, information related to a cell DTX/DRX configuration associated with the network node. The PDCCH monitoring component 808 may monitor, after completion of the RACH procedure, PDCCH occasions starting at or after a beginning of a subsequent cell DTX active time associated with the cell DTX/DRX configuration.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

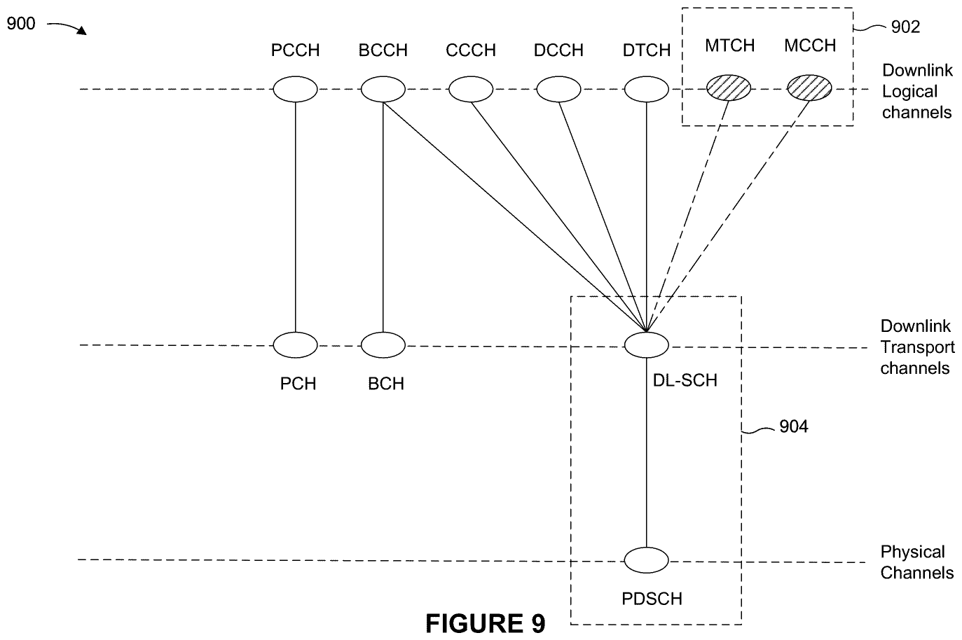

FIG. 9 is a diagram illustrating an example 900 of a channel mapping for multicast/broadcast service (MBS) in accordance with the present disclosure. As shown by a first mapping 902 to downlink logical channels, MBS transmissions in an NR network may be supported using a multicast traffic channel (MTCH) (sometimes referred to as a multicast broadcast traffic channel (MBTCH)) and a multicast control channel (MCCH) (sometimes referred to as a multicast broadcast control channel (MBCCH)). The MTCH may carry multicast or broadcast data, while the MCCH may carry configuration information or control information for multicast or broadcast communications to be transmitted on the MTCH. An MBS communication on the MTCH may be addressed to a group of UEs using a group common radio network temporary identifier (G-RNTI).

In some aspects, different MTCHs may be used to carry multicast broadcast traffic with different quality of service (QOS) requirements. An MBS traffic flow with associated QoS requirements or QoS parameters (for example, a group of related packets for the same multicast broadcast service) may be referred to as an MB-QoS flow. In some aspects, there may be a one-to-one mapping between MB-QOS flows and MTCHs. A network node or a core network device may configure a multicast broadcast radio bearer (MRB) for an MB-QoS flow. In some aspects, there may be a one-to-one mapping between MB-QoS flows and MRBs. Accordingly, each MTCH may correspond to an MRB for carrying an MB-QoS flow.

The MCCH may carry configuration information for configuring the MTCHs, and may be addressed to all UEs in a cell (for example, a physical cell or a virtual cell) using a single cell RNTI (SC-RNTI). In some aspects, there may be a single MCCH per cell (physical cell or virtual cell), and the MCCH may carry MTCH configuration information for multiple MBSs with different MB-QoS flows. As shown by a second mapping 904, the MCCH and the MTCH are logical channels, and may be mapped to a downlink shared channel (UESCH) transport channel, which may be mapped to a PDSCH.

In cases where a network node providing MBS communications is operating in accordance with a cell DTX/DRX configuration, there are various circumstances in which an MBS UE (for example, a UE receiving multicast or broadcast transmissions) may waste power attempting to decode one or more MBS channels during the inactive time of the cell DTX/DRX configuration. For example, for a UE in an RRC idle or RRC inactive state, a network node indicates a broadcast common frequency resource (CFR) and a broadcast MCCH configuration in a SIB, and a broadcast MTCH configuration is broadcasted in an MCCH transmission. Furthermore, for a UE in an RRC idle or RRC inactive state, a network node indicates a multicast CFR and a multicast MCCH configuration in a SIB, and a multicast MTCH configuration is indicated in a multicast MCCH transmission. However, in cases where the network node drops MBS MCCH transmissions during the inactive time of the cell DTX/DRX configuration, a UE receiving MBS transmissions has no indication that the MBS MCCH transmissions are being dropped, which may lead to increased power consumption and/or wasted power when the UE attempts to decode the MBS MCCH during the inactive time of the cell DTX/DRX configuration. Furthermore, in cases where the network node drops MBS MTCH transmissions during the inactive time of the cell DTX/DRX configuration before the UE becomes aware of the cell DTX/DRX configuration, the UE will continue to expect MBS MTCH transmissions during the inactive time of the cell DTX/DRX configuration, which leads to wasted power. Accordingly, some aspects described herein relate to techniques that may enable a UE receiving MBS transmissions to decode MCCH transmissions without attempting to decode MTCH transmissions during the inactive time of a cell DTX/DRX configuration (for example, if the inactive time of the cell DTX/DRX configuration starts between an MCCH transmission and an MTCH transmission).

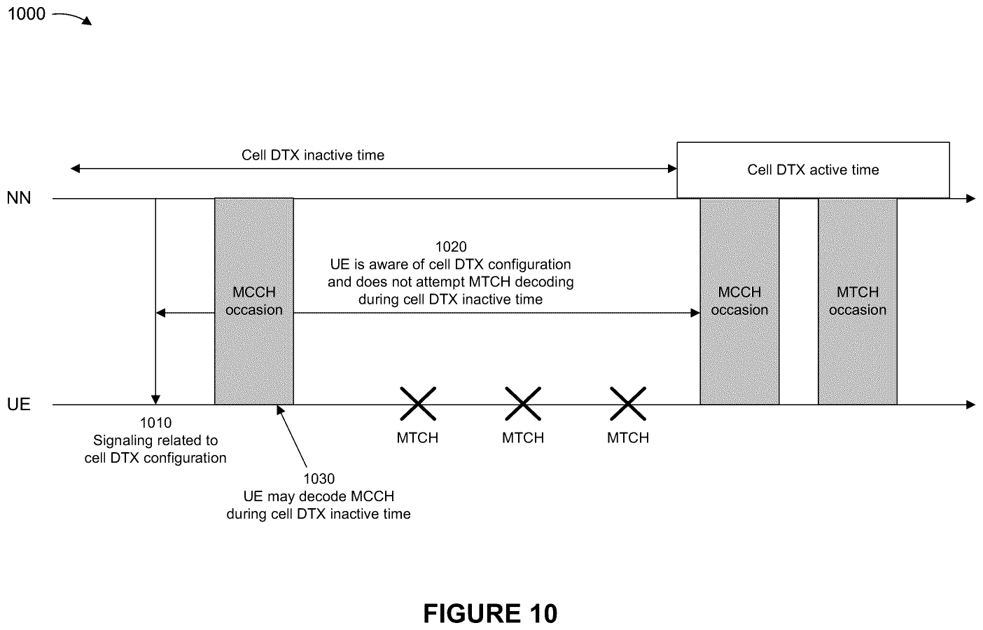

FIG. 10 is a diagram illustrating an example of early cell DTX/DRX signaling in accordance with the present disclosure. As shown in FIG. 10, example 1000 includes communication between a network node (for example, network node 110 or 210) and a UE (for example, UE 120 or 220). In some aspects, the network node and the UE may communicate in a wireless network, such as wireless network 100. The network node and the UE may communicate via a wireless access link, which may include an uplink and a downlink.

As shown in FIG. 10, in a first operation 1010, the network node may transmit, and the UE may receive, signaling related to a cell DTX configuration associated with the network node. For example, as described herein, the network node may support or otherwise provide an MBS, and the cell DTX configuration may include a cell DTX active time during which the network node is transmitting MBS communications and a cell DTX inactive time during which the network node is transmitting only system information, paging messages, and RACH messages (for example, MCCH and/or MTCH communications are dropped during the cell DTX inactive time). For example, in some aspects, the cell DTX configuration may be signaled in a SIB for one or more UEs that are receiving MBS transmissions (for example, a first SIB, such as SIB20 or another suitable SIB, for UEs receiving broadcast transmissions, or a second SIB for UEs receiving multicast transmissions). Additionally or alternatively, the cell DTX configuration associated with the network node may be signaled in an MBS configuration, such as an MBSBroadcastConfiguration carried in a broadcast MCCH transmission for broadcast MTCH transmissions or an MBSMulticastConfiguration carried in a multicast MCCH transmission for multicast MTCH transmissions. For example, in some aspects, the cell DTX configuration may be signaled in the MBS configuration in cases where the network node drops MTCH transmissions during the inactive time of the cell DTX configuration while continuing to transmit MCCH transmissions during the inactive time of the cell DTX configuration.

Accordingly, in a second operation 1020, the UE is aware of the cell DTX configuration and refrains from attempting to decode MTCH transmissions that occur during the inactive time of the cell DTX configuration. Furthermore, in some aspects, the UE may refrain from attempting to decode MCCH transmissions that occur during the inactive time of the cell DTX configuration (for example, in cases where the network node drops MCCH transmissions during the inactive time of the cell DTX configuration). Alternatively, in a third operation 1030, the UE may attempt to decode MCCH transmissions that occur during the inactive time of the cell DTX configuration (for example, in cases where the network node does not drop MCCH transmissions during the inactive time of the cell DTX configuration). In any case, the UE may attempt to decode MTCH transmissions starting at or after the beginning of a next active time associated with the cell DTX configuration, thereby saving power that would have otherwise been wasted by attempting to decode MTCH transmissions that are dropped during the inactive time of the cell DTX configuration. Furthermore, in cases where the UE does not attempt to decode MCCH transmissions during the inactive time of the cell DTX configuration, the UE may attempt to decode MCCH transmissions starting at or after the beginning of the next active time associated with the cell DTX configuration, thereby saving power that would have otherwise been wasted by attempting to decode MCCH transmissions that are dropped during the inactive time of the cell DTX configuration.

FIG. 11 is a flowchart illustrating an example process 1100 performed, for example, by a UE that supports early cell DTX/DRX signaling in accordance with the present disclosure. Example process 1100 is an example where the UE (for example, UE 120 or UE 220) performs operations associated with early cell DTX/DRX signaling.

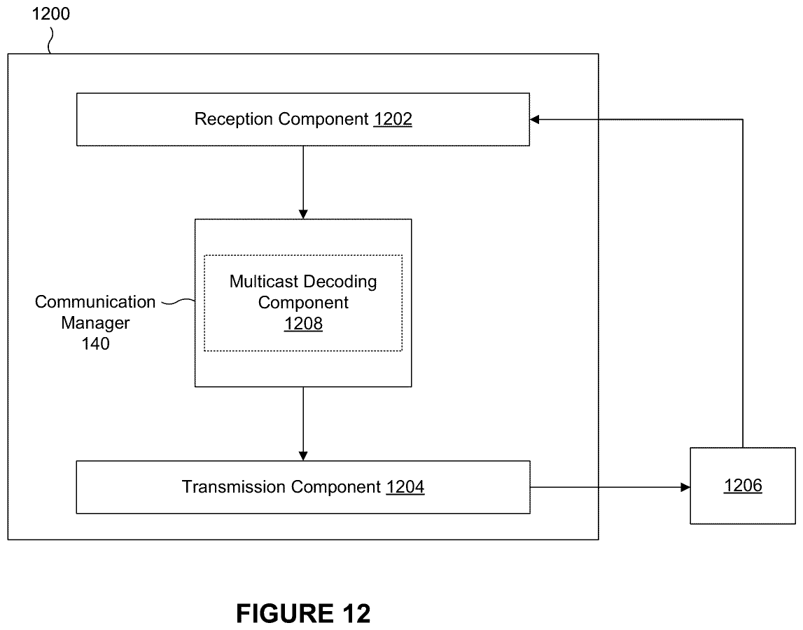

As shown in FIG. 11, in some aspects, process 1100 may include receiving, from a network node, information related to a cell DTX configuration associated with MBS provided by the network node (block 1110). For example, the UE (such as by using communication manager 140 or reception component 1202, depicted in FIG. 12) may receive, from a network node, information related to a cell DTX configuration associated with MBS provided by the network node, as described above.

As further shown in FIG. 11, in some aspects, process 1100 may include attempting to decode an MTCH starting at or after a beginning of a subsequent cell DTX inactive time associated with the cell DTX configuration (block 1120). For example, the UE (such as by using communication manager 140 or multicast decoding component 1208, depicted in FIG. 12) may attempt to decode an MTCH starting at or after a beginning of a subsequent cell DTX inactive time associated with the cell DTX configuration, as described above.

Process 1100 may include additional aspects, such as any single aspect or any combination of aspects described below or in connection with one or more other processes described elsewhere herein.

In a first additional aspect, the information related to the cell DTX configuration is received in a SIB.

In a second additional aspect, alone or in combination with the first aspect, the information related to the cell DTX configuration is received in an MBS configuration carried in an MCCH transmission.

In a third additional aspect, alone or in combination with one or more of the first and second aspects, process 1100 includes attempting to decode an MCCH starting at or after the beginning of the subsequent cell DTX inactive time associated with the cell DTX configuration.

In a fourth additional aspect, alone or in combination with one or more of the first through third aspects, process 1100 includes attempting to decode an MCCH during the cell DTX inactive time associated with the cell DTX configuration, prior to the beginning of the subsequent cell DTX inactive time associated with the cell DTX configuration.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports early cell DTX/DRX signaling in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIG. 10. Additionally or alternatively, the apparatus 1200 may be configured to and/or operable to perform one or more processes described herein, such as process 1100 of FIG. 11. In some aspects, the apparatus 1200 may include one or more components of the UE described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, and/or a memory of the UE described above in connection with FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, and/or a memory of the UE described above in connection with FIG. 2. In some aspects, the transmission component 1204 may be co-located with the reception component 1202 in a transceiver.

The communication manager 140 may receive or may cause the reception component 1202 to receive, from a network node, information related to a cell DTX configuration associated with MBS provided by the network node. The communication manager 140 may attempt to decode an MTCH starting at or after a beginning of a subsequent cell DTX inactive time associated with the cell DTX configuration. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as a multicast decoding component 1208. Alternatively, the set of components may be separate and distinct from the communication manager 140. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive, from a network node, information related to a cell DTX configuration associated with MBS provided by the network node. The multicast decoding component 1208 may attempt to decode an MTCH starting at or after a beginning of a subsequent cell DTX inactive time associated with the cell DTX configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: communicating with a network node to perform a RACH procedure; receiving, from the network node prior to commencement or completion of the RACH procedure, information related to a cell DTX/DRX configuration associated with the network node; and monitoring, after completion of the RACH procedure, PDCCH occasions starting at or after a beginning of a subsequent cell DTX active time associated with the cell DTX/DRX configuration.

Aspect 2: The method of Aspect 1, wherein the cell DTX/DRX configuration is associated with a current serving cell associated with the network node, wherein the RACH procedure is performed with the current serving cell, and wherein the information related to the cell DTX/DRX configuration is received in a SIB that indicates an activation state or activation time for the cell DTX/DRX configuration, the SIB being received prior to the commencement of the RACH procedure.

Aspect 3: The method of any of Aspects 1-2, wherein the cell DTX/DRX configuration is associated with a neighbor cell associated with the network node, wherein the RACH procedure is performed with the neighbor cell, and wherein the information related to the cell DTX/DRX configuration is received in a SIB that indicates a time-to-expire for the cell DTX/DRX configuration, the SIB being received prior to the commencement of the RACH procedure.

Aspect 4: The method of any of Aspects 1-3, wherein the cell DTX/DRX configuration is associated with a current serving cell associated with the network node, wherein the RACH procedure is performed with the current serving cell, and wherein the information related to the cell DTX/DRX configuration is received in a paging message that indicates an activation state for the cell DTX/DRX configuration, the paging message being received prior to the commencement of the RACH procedure.

Aspect 5: The method of any of Aspects 1-4, wherein the information related to the cell DTX/DRX configuration includes a reference time when the UE is to start to monitor the PDCCH occasions.

Aspect 6: The method of any of Aspects 1-5, wherein the information related to the cell DTX/DRX configuration is received during the RACH procedure in a downlink message indicating a time delay until the subsequent cell DTX active time.

Aspect 7: The method of Aspect 6, further comprising: transmitting, to the network node, a PUCCH message to acknowledge a final downlink message associated with the RACH procedure, wherein the time delay starts from a symbol in which the PUCCH message is transmitted.

Aspect 8: The method of any of Aspects 6-7, wherein the time delay is indicated as a number of symbols associated with an SCS.

Aspect 9: The method of any of Aspects 6-9, wherein the time delay is indicated as a number of time units.

Aspect 10: The method of any of Aspects 1-9, further comprising: transmitting, after completion of the RACH procedure, one or more uplink signals starting at or after the beginning of the subsequent cell DRX active time in accordance with an indication of whether a default uplink or downlink channel restriction is applicable during an inactive time associated with the cell DTX/DRX configuration.

Aspect 11: The method of Aspect 10, further comprising: receiving, during the RACH procedure, the indication of whether the default uplink or downlink channel restriction is applicable during the inactive time associated with the cell DTX/DRX configuration.

Aspect 12: The method of any of Aspects 1-11, wherein the information related to the cell DTX/DRX configuration is received in a SIB prior to the commencement of the RACH procedure, and wherein communicating with the network node to perform the RACH procedure includes receiving a message that indicates an activation state or an activation time for the cell DTX/DRX configuration during the RACH procedure.

Aspect 13: The method of any of Aspects 1-12, wherein the information related to the cell DTX/DRX configuration includes a SIB that indicates multiple candidate cell DTX/DRX configurations, and wherein communicating with the network node to perform the RACH procedure includes receiving, during the RACH procedure, a message that indicates, among the multiple candidate cell DTX/DRX configurations, an active cell DTX/DRX configuration.

Aspect 14: A method of wireless communication performed by a UE, comprising: receiving, from a network node, information related to a cell DTX configuration associated with MBS provided by the network node; and attempting to decode an MTCH starting at or after a beginning of a subsequent cell DTX inactive time associated with the cell DTX configuration.

Aspect 15: The method of Aspect 14, wherein the information related to the cell DTX configuration is received in a SIB.

Aspect 16: The method of any of Aspects 14-15, wherein the information related to the cell DTX configuration is received in an MBS configuration carried in an MCCH transmission.

Aspect 17: The method of any of Aspects 14-16, further comprising: attempting to decode an MCCH starting at or after the beginning of the subsequent cell DTX inactive time associated with the cell DTX configuration.

Aspect 18: The method of any of Aspects 14-17, further comprising: attempting to decode an MCCH during the cell DTX inactive time associated with the cell DTX configuration, prior to the beginning of the subsequent cell DTX inactive time associated with the cell DTX configuration.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories storing processor-readable code; and
one or more processors coupled with the one or more memories and operable to cause the UE to:
communicate with a network node to perform a random access channel (RACH) procedure;
receive, from the network node prior to commencement or completion of the RACH procedure, information related to a cell discontinuous transmission (DTX) or discontinuous reception (DRX) (DTX/DRX) configuration associated with the network node; and
monitor, after completion of the RACH procedure, physical downlink control channel (PDCCH) occasions starting at or after a beginning of a subsequent cell DTX active time associated with the cell DTX/DRX configuration.

2. The UE of claim 1, wherein the cell DTX/DRX configuration is associated with a current serving cell associated with the network node, wherein the RACH procedure is performed with the current serving cell, and wherein the information related to the cell DTX/DRX configuration is received in a system information block (SIB) that indicates an activation state or activation time for the cell DTX/DRX configuration, the SIB being received prior to the commencement of the RACH procedure.

3. The UE of claim 1, wherein the cell DTX/DRX configuration is associated with a neighbor cell associated with the network node, wherein the RACH procedure is performed with the neighbor cell, and wherein the information related to the cell DTX/DRX configuration is received in a system information block (SIB) that indicates a time-to-expire for the cell DTX/DRX configuration, the SIB being received prior to the commencement of the RACH procedure.

4. The UE of claim 1, wherein the cell DTX/DRX configuration is associated with a current serving cell associated with the network node, wherein the RACH procedure is performed with the current serving cell, and wherein the information related to the cell DTX/DRX configuration is received in a paging message that indicates an activation state for the cell DTX/DRX configuration, the paging message being received prior to the commencement of the RACH procedure.

5. The UE of claim 1, wherein the information related to the cell DTX/DRX configuration includes a reference time when the UE is to start to monitor the PDCCH occasions.

6. The UE of claim 1, wherein the information related to the cell DTX/DRX configuration is received during the RACH procedure in a downlink message indicating a time delay until the subsequent cell DTX active time.

7. The UE of claim 6, wherein the one or more processors are further operable to cause the UE to:
transmit, to the network node, a physical uplink control channel (PUCCH) message to acknowledge a final downlink message associated with the RACH procedure, wherein the time delay starts from a symbol in which the PUCCH message is transmitted.

8. The UE of claim 6, wherein the time delay is indicated as a number of symbols associated with a subcarrier spacing (SCS).

9. The UE of claim 6, wherein the time delay is indicated as a number of time units.

10. The UE of claim 1, wherein the one or more processors are further operable to cause the UE to:
transmit, after completion of the RACH procedure, one or more uplink signals starting at or after the beginning of the subsequent cell DRX active time in accordance with an indication of whether a default uplink or downlink channel restriction is applicable during an inactive time associated with the cell DTX/DRX configuration.

11. The UE of claim 9, wherein the one or more processors are further operable to cause the UE to:
receive, during the RACH procedure, the indication of whether the default uplink or downlink channel restriction is applicable during the inactive time associated with the cell DTX/DRX configuration.

12. The UE of claim 1, wherein the information related to the cell DTX/DRX configuration is received in a system information block (SIB) prior to the commencement of the RACH procedure, and wherein the one or more processors, to communicate with the network node to perform the RACH procedure, are further operable to cause the UE to receive a message that indicates an activation state or an activation time for the cell DTX/DRX configuration during the RACH procedure.

13. The UE of claim 1, wherein the information related to the cell DTX/DRX configuration includes a system information block (SIB) that indicates multiple candidate cell DTX/DRX configurations, and wherein the one or more processors, to communicate with the network node to perform the RACH procedure, are further operable to cause the UE to receive, during the RACH procedure, a message that indicates, among the multiple candidate cell DTX/DRX configurations, an active cell DTX/DRX configuration.

14. A user equipment (UE) for wireless communication, comprising:
one or more memories storing processor-readable code; and
one or more processors coupled with the one or more memories and operable to cause the UE to:
receive, from a network node, information related to a cell discontinuous transmission (DTX) configuration associated with multicast/broadcast service (MBS) provided by the network node; and
attempt to decode a multicast traffic channel (MTCH) starting at or after a beginning of a subsequent cell DTX inactive time associated with the cell DTX configuration.

15. The UE of claim 14, wherein the information related to the cell DTX configuration is received in a system information block (SIB).

16. The UE of claim 14, wherein the information related to the cell DTX configuration is received in an MBS configuration carried in a multicast control channel (MCCH) transmission.

17. The UE of claim 14, wherein the one or more processors are further operable to cause the UE to:
attempt to decode a multicast control channel (MCCH) starting at or after the beginning of the subsequent cell DTX inactive time associated with the cell DTX configuration.

18. The UE of claim 14, wherein the one or more processors are further operable to cause the UE to:
attempt to decode a multicast control channel (MCCH) during the cell DTX inactive time associated with the cell DTX configuration, prior to the beginning of the subsequent cell DTX inactive time associated with the cell DTX configuration.

19. A method of wireless communication performed by a user equipment (UE), comprising:
communicating with a network node to perform a random access channel (RACH) procedure;
receiving, from the network node prior to commencement or completion of the RACH procedure, information related to a cell discontinuous transmission (DTX) or discontinuous reception (DRX) (DTX/DRX) configuration associated with the network node; and
monitoring, after completion of the RACH procedure, physical downlink control channel (PDCCH) occasions starting at or after a beginning of a subsequent cell DTX active time associated with the cell DTX/DRX configuration.

20. The method of claim 19, wherein the cell DTX/DRX configuration is associated with a current serving cell associated with the network node, wherein the RACH procedure is performed with the current serving cell, and wherein the information related to the cell DTX/DRX configuration is received in a system information block (SIB) that indicates an activation state or activation time for the cell DTX/DRX configuration, the SIB being received prior to the commencement of the RACH procedure.

21. The method of claim 19, wherein the cell DTX/DRX configuration is associated with a neighbor cell associated with the network node, wherein the RACH procedure is performed with the neighbor cell, and wherein the information related to the cell DTX/DRX configuration is received in a system information block (SIB) that indicates a time-to-expire for the cell DTX/DRX configuration, the SIB being received prior to the commencement of the RACH procedure.

22. The method of claim 19, wherein the cell DTX/DRX configuration is associated with a current serving cell associated with the network node, wherein the RACH procedure is performed with the current serving cell, and wherein the information related to the cell DTX/DRX configuration is received in a paging message that indicates an activation state for the cell DTX/DRX configuration, the paging message being received prior to the commencement of the RACH procedure.

23. The method of claim 19, wherein the information related to the cell DTX/DRX configuration includes a reference time when the UE is to start to monitor the PDCCH occasions.

24. The method of claim 19, wherein the information related to the cell DTX/DRX configuration is received during the RACH procedure in a downlink message indicating a time delay until the subsequent cell DTX active time.

25. The method of claim 19, further comprising:
transmitting, after completion of the RACH procedure, one or more uplink signals starting at or after the beginning of the subsequent cell DRX active time in accordance with an indication of whether a default uplink or downlink channel restriction is applicable during an inactive time associated with the cell DTX/DRX configuration.

26. The method of claim 19, wherein the information related to the cell DTX/DRX configuration is received in a system information block (SIB) prior to the commencement of the RACH procedure, and wherein communicating with the network node to perform the RACH procedure includes receiving a message that indicates an activation state or an activation time for the cell DTX/DRX configuration during the RACH procedure.

27. The method of claim 19, wherein the information related to the cell DTX/DRX configuration includes a system information block (SIB) that indicates multiple candidate cell DTX/DRX configurations, and wherein communicating with the network node to perform the RACH procedure includes receiving, during the RACH procedure, a message that indicates, among the multiple candidate cell DTX/DRX configurations, an active cell DTX/DRX configuration.

28. A method of wireless communication performed by a user equipment (UE), comprising:
Receiving, from a network node, information related to a cell discontinuous transmission (DTX) configuration associated with multicast/broadcast service (MBS) provided by the network node; and
attempting to decode a multicast traffic channel (MTCH) starting at or after a beginning of a subsequent cell DTX inactive time associated with the cell DTX configuration.

29. The method of claim 28, wherein the information related to the cell DTX configuration is received in a system information block (SIB).

30. The method of claim 28, wherein the information related to the cell DTX configuration is received in an MBS configuration carried in a multicast control channel (MCCH) transmission.
